(19) United States
(12) Patent Application Publication
(10) Pub. No.: US 2026/0282091 A1
(43) Pub. Date: Sep. 17, 2026

(54) METHOD AND SYSTEM FOR PROVIDING ISAC SUPPORT FUNCTION OF NF IN MOBILE COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Nam Seok KO, Daejeon (KR)

(73) Assignee: ELECTRONICS AND TELECOMMUNICATIONS RESEARCH INSTITUTE, Daejeon (KR)

(21) Appl. No.: 19/566,126

(22) Filed: Mar. 13, 2026

(30) Foreign Application Priority Data
Mar. 14, 2025 (KR) 10-2025-0033274
May 8, 2025 (KR) 10-2025-0059440
May 8, 2025 (KR) 10-2025-0060002
Jan. 28, 2026 (KR) 10-2026-0017276

(51) Int. Cl. H04W 74/0816; H04L 41/16; H04W 12/06; H04W 60/04

(52) U.S. Cl. CPC H04W 74/0816; H04L 41/16; H04W 12/06; H04W 60/04

(57) ABSTRACT

Provided is a method which provides ISAC-related information in a wireless communication system. The method includes registering, by a sensing function (SF) having a sensing function, sensing-related information with a network repository function (NRF) via a service based interface (SBI), searching for, by a network function (NF), at least one SF from the NRF via the SBI based on a first service, selecting a first SF corresponding to the first service among the at least one SF, and obtaining sensing data via at least one entity instructed by the first SF.

### CROSS-REFERENCE TO RELATED APPLICATIONS

This application claims priority under 35 U.S.C. § 119 to Korean Patent Application No. 10-2025-0033274 filed on Mar. 14, 2025, No. 10-2025-0060002 filed on May 8, 2025, No. 10-2025-0059440 filed on May 8, 2025, No. 10-2026-0017276 filed on Jan. 28, 2026 in the Korean Intellectual Property Office, the disclosures of which are incorporated by reference herein in their entireties.

### BACKGROUND

Embodiments of the present disclosure described herein relate to a method and a system for providing an integrated sensing and communications (ISAC) function in a mobile communication system. In detail, embodiments of the present disclosure described herein relate to a communication procedure between a sensing entity and network functions (NFs) supporting the ISAC function. Furthermore, embodiments of the present disclosure described herein relate to a method and an apparatus for connecting at least any one of a sensing function (SF) and a gateway mobile sensing center (GMSC) based on a service based interface (SBI) and support the ISAC function.

As a new service, such as 5th generation (5G) or an Internet of things (IoT), emerges, a future application service requires a network technology for providing a stronger programming possibility and a simpler integrated network solution. 5G has been developed based on a service scenario of enhanced mobile broadband (eMBB), massive machine type communication (mMTC), and ultra-reliable low latency (uRLLC).

An integrated sensing and communications (ISAC) technology for performing a wireless communication function and an external environment detection function as well as the above-mentioned requirements in a single wireless interface in an integrated manner may be applied in a next-generation mobile communication system. Hereinafter, a description will be given of it. Furthermore, only an existing architecture may have a limitation in providing a complex service. Considering the above points, the next-generation mobile communication system may consider a service-based architecture (SBA) as a new architecture. Hereinafter, a description will be given of an operation based on it.

### SUMMARY

Embodiments of the present disclosure provide a method and a system for providing an ISAC function in a mobile communication system.

Embodiments of the present disclosure provide a method and an apparatus for performing communication between a sensing entity and network functions (NFs) supporting an ISAC function.

Embodiments of the present disclosure provide a method and an apparatus for having at least any one of an SF and a GMSC to support an ISAC function, based on an SBI.

Embodiments of the present disclosure provide a method and an apparatus for delivering integrated sensing and communications (ISAC) function information to an access management function (AMF) in an NG-RAN node supporting an ISAC function.

Embodiments of the present disclosure provide a method and an apparatus for performing registration with a network repository function (NRF) in an SF, an AMF, a session management function (SMF), and a user plane function (UPF) supporting an ISAC function.

Embodiments of the present disclosure provide a method and an apparatus for searching for an SF, an AMF, an SMF, and a UPF having an ISAC function via an NRF in an NF.

The technical purposes which the present disclosure is intended for are not limited to the technical purposes set forth above. Other technical purposes not mentioned may be clearly understood by those skilled in the art to which the present invention belongs from the following description.

According to an embodiment, a method for providing integrated sensing and communications (ISAC)-related information in a wireless communication system may include registering, by a sensing function (SF) having a sensing function, sensing-related information with a network repository function (NRF) via a service based interface (SBI), searching for, by a network function (NF), at least one SF from the NRF via the SBI based on a first service, selecting a first SF corresponding to the first service among the at least one SF, and obtaining sensing data via at least one entity instructed by the first SF.

According to an embodiment, an apparatus for providing integrated sensing and communications (ISAC)-related information in a wireless communication system may include a memory storing at least one program, a transceiver that transmits and receives at least one signal, and a processor that executes the at least one program stored in the memory. The processor may register sensing-related information with a network repository function (NRF) via a service based interface (SBI) in a sensing function (SF) having a sensing function, may search for at least one SF from the NRF via the SBI based on a first service in a network function (NF), may select a first SF corresponding to the first service among the at least one SF, and may obtain sensing data via at least one entity instructed by the first SF.

Furthermore, the following items may be applied in common.

According to an embodiment, the SF may include a parameter for at least any one of an SF ID, sensing target types, access types, access node types, radio access technology (RAT) types, sensing service types, support artificial intelligence (AI), sensing modes, sensing measurements, a target sensing service area, a moving target sensing service area, sensing exposure information, transparent sensing, sensing client types, a sensing load, network slice information, an SF location, performance requirements, a serving sensing protocol, a serving user plane sensing protocol, and serving sensing capabilities. The first SF may be selected among the at least one SF based on the at least one parameter.

Furthermore, according to an embodiment, the SF having the sensing function may provide the NRF with an NF profile based on the at least one parameter.

Furthermore, according to an embodiment, when an access management function (AMF) supporting the sensing function is registered to the NRF via the SBI and the NRF performs a sensing operation via the first SF selected based on the first service, the AMF supporting the sensing function among at least one AMF may be selected.

Furthermore, according to an embodiment, when the AMF obtains at least any one of sensing capability information and sensing radio capability information from at least any one of a user terminal and a base station as sensing entities and the AMF supporting the sensing function is selected, selection for the AMF may be performed based on the information obtained by the AMF.

Furthermore, according to an embodiment, when a session management function (SMF) supporting the sensing function is registered to the NRF via the SBI and the NRF performs a sensing operation via the first SF selected based on the first service, the SMF supporting the sensing function among at least one SMF may be selected.

Furthermore, according to an embodiment, when a user plane function (UPF) supporting the sensing function is registered to the NRF via the SBI and the NRF performs a sensing operation via the first SF selected based on the first service, the UPF supporting the sensing function among at least one UPF may be selected.

Furthermore, according to an embodiment, when the UPF is registered to the NRF based on a user plane function feature including whether to support the sensing function and a sensing support function and the UPF supporting the sensing function is selected, selection for the UPF may be performed based on whether the UPF supports the sensing function and whether the UPF includes the sensor support function.

Furthermore, according to an embodiment, a network exposure function (NEF) may receive a sensing service request from at least any one of an application function (AF) and a gateway mobile sensing center (GMSC) and sensing service authentication may be performed based on the sensing service request. A sensing function (SF) may be selected based on the sensing service authentication and sensing data obtained via at least one sensing entity instructed by the selected SF may be delivered to the at least any one of the AF and the GMSC.

Furthermore, according to an embodiment, when a sensing client is connected with the GMSC and the GMSC is connected via a service based interface (SBI), the NEF may deliver the sensing data to the sensing client via the GMSC.

Furthermore, according to an embodiment, when a sensing client is connected with the SF, the NEF may deliver the sensing data to the sensing client via the SF.

Furthermore, according to an embodiment, the NEF may perform the sensing service authentication based on at least any one of an AF ID, a client ID, a sensing service type, purpose of sensing, an identifier of a terminal, a sensing group, a sensing service area, a time period for sensing, QoS requirements, accuracy of velocity estimate, a confidence level, a missed detection probability, a false alarm probability, max sensing service latency, a sensing report description, a response type, and a sensing event type based on the sensing service request of the at least any one of the AF and the GMSC.

### BRIEF DESCRIPTION OF THE FIGURES

The above and other objects and features of the present disclosure will become apparent by describing in detail embodiments thereof with reference to the accompanying drawings.

FIG. 1 is a conceptual diagram illustrating a mobile communication system applicable to the present disclosure.

FIG. 2 is a drawing illustrating a device configuration applicable to the present disclosure.

FIG. 3 is a drawing illustrating reference points applicable to the present disclosure.

FIG. 4 is a drawing illustrating a system architecture including an NF supporting an integrated sensing and communications function applied to the present disclosure.

FIGS. 5A and 5B are drawings illustrating a method for registering and requesting an NF profile from an NRF in an SF applied to the present disclosure.

FIG. 6 is a drawing illustrating a terminal information exchange procedure between an NG-RAN node including ISAC information and an AMF applied to the present disclosure.

FIGS. 7A, 7B, and 7C are drawings illustrating an operation between network functions applied to the present disclosure.

FIG. 8 is a drawing illustrating a GMSC based sensing service providing procedure applied to the present disclosure.

FIG. 9A and FIG. 9B are drawings illustrating a GMSC based expansion sensing service providing procedure applied to the present disclosure.

FIG. 10 is a drawing illustrating a UE-AMF direct based sensing service providing procedure applied to the present disclosure.

FIGS. 11A and 11B are drawings illustrating a GMSC based expansion sensing service providing procedure applied to the present disclosure.

FIG. 12 is a drawing illustrating a GMSC and AMF based mixed sensing service providing procedure applied to the present disclosure.

FIGS. 13A and 13B are drawing illustrating a process of providing a sensing service via procedural linkage among a sensing client, a UDM, an AMF, and an SF according to the present disclosure.

FIG. 14 is a drawing illustrating a UE based sensing service providing procedure using an AMF and an SF according to the present disclosure.

FIGS. 15A and 15B are drawings illustrating a procedure of directly selecting an SF and requesting a sensing service in a sensing client according to the present disclosure.

FIG. 16 is a drawing illustrating a GMSC based sensing service providing procedure according to the present disclosure.

FIG. 17 is a drawing illustrating a procedure of collecting a sensing data sample to train an ML model in an NWDAF according to the present disclosure.

FIG. 18 is a drawing illustrating a procedure of obtaining trained ML model information from an NWDAF to improve sensing accuracy in an SF according to the present disclosure.

FIG. 19 is a drawing illustrating a procedure for registering sensing function information to a network in UE according to the present disclosure.

FIG. 20 is a drawing illustrating a procedure for registering sensing function information to a network in an NG-RAN according to the present disclosure.

FIG. 21 is a drawing illustrating a procedure for delivering NAS based sensing information among UE-NG-RAN-AMF-SF using a Sensing Protocol PDU according to the present disclosure.

FIG. 22 is a drawing illustrating an N2 based delivery procedure of a Sensing Protocol PDU among NG-RAN-AMF-SF according to the present disclosure.

FIG. 23 is a drawing illustrating a user plane establishment procedure between UE-SF for user plane based sensing protocol delivery according to the present disclosure.

FIG. 24 is a drawing illustrating a user-initiated user plane sensing protocol establishment procedure according to the present disclosure.

FIG. 25 is a flowchart illustrating a method for providing ISAC-related information applied to the present disclosure.

### DETAILED DESCRIPTION

While the present disclosure is susceptible to various modifications and alternative forms and may have several embodiments, specific embodiments thereof are shown by way of examples in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

Although the terms “first,” “second,” etc. may be used herein in describing various components, the components should not be construed as being limited by these terms. The terms are only used to distinguish one component from another component. For example, a first component may be termed a second component without departing from the scope of the claims of the present disclosure, and similarly, a second component may be termed a first component. The term “and/or” includes any and all combinations of the plurality of associated listed items.

In embodiments of the present application, “at least one of A and B” may refer to “at least one of A or B” or “at least one of combinations of one or more of A and B”. Furthermore, in embodiments of the present application, “one or more of A and B” may refer to “one or more of A or B” or “one or more of combinations of one or more of A and B”.

In embodiments of the present application, (re) transmission may refer to “transmission”, “retransmission”, or “transmission and retransmission”, (re)configuration may refer to “configuration”, “reconfiguration”, or “configuration and “reconfiguration”, (re) connection may refer to “connection”, “reconnection”, or “connection and reconnection”, and (re)-access may refer to “access”, “re-access”, or “access and re-access”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present application are only used to describe specific embodiments, and are not intended to limit the present disclosure. The singular expression includes the plural expression unless the context clearly dictates otherwise. In the present application, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms, including technical and scientific terms, used herein have the same meaning as commonly understood by one of ordinary skill in the art to which this disclosure belongs. Terms, such as those defined in commonly used dictionaries, should be interpreted as having a meaning that is consistent with their meaning in the context of the relevant art and will not be interpreted in an idealized or overly formal sense unless expressly so defined in the present application.

Hereinafter, embodiments of the present disclosure will be described in detail with reference to the accompanying drawings. In describing the present disclosure, to facilitate the entire understanding of the present disclosure, like numbers refer to like components throughout the description of the figures and the repetitive description thereof will be omitted.

A description will be given of a communication network to which embodiments according to the present disclosure are applied. The communication network may be a non-terrestrial network (NTN), a 4th generation (4G) communication network (i.e., a long-term evolution (LTE) communication network), a 5th generation (5G) communication network (e.g., a new ratio (NR) communication network), or the like. Furthermore, as an example, a next-generation communication network may be a 6th generation (6G) communication network, a new type of communication network, or the like and is not limited to a specific form. In the entire specification, a network may include, for example, a wireless Internet, such as wireless fidelity (WiFi), a portable Internet, such as wireless broadband Internet (WiBro) or world interoperability for microwave access (WiMax), a 2nd generation (2G) mobile communication network, such as global system for mobile communication (GSM) or code division multiple access (CDMA), a 3rd generation (3G) mobile communication network, such as wideband code division multiple access (WCDMA) or CDMA2000, a 3.5th generation (3.5G) mobile communication network, such as high speed downlink packet access (HSDPA) or high speed uplink packet access (HSUPA), a 4G mobile communication network, such as a long term evolution (LTE) network or an LTE-Advanced network, a 5G mobile communication network, such as NR, a 6G communication network or the other networks as the other next-generation communication networks, and the like and is not limited to a specific form.

In the entire specification, a terminal may be referred to as an access terminal, a mobile terminal, a station, a subscriber station, a mobile station, a portable subscriber station, a node, a device, or the like.

Herein, a communicable desktop computer, a laptop computer, a tablet PC, a wireless phone, a mobile phone, a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, or the like may be used as the terminal.

In the entire specification, a base station may be referred to as NodeB, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like.

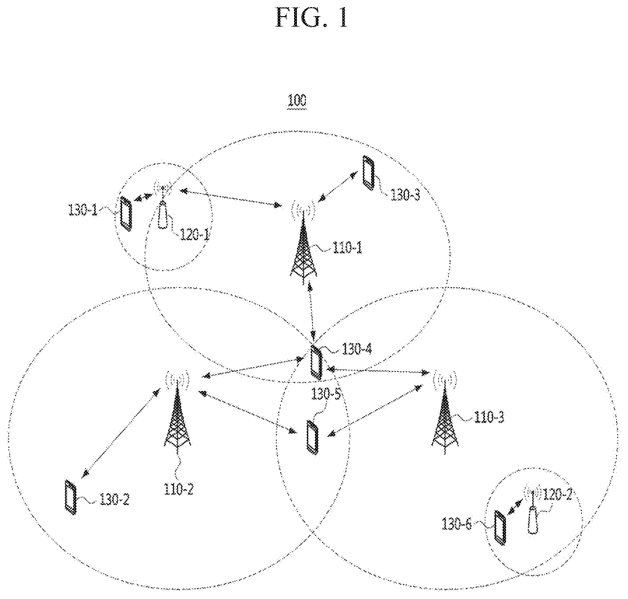

FIG. 1 is a conceptual diagram illustrating a mobile communication system according to an embodiment.

Referring to FIG. 1, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communication (e.g., long term evolution (LTE) or LTE-advanced (LTE-A)), 5G communication (e.g., new radio (NR)), next-generation communication (e.g., 6G), and the like defined in the 3rd generation partnership project (3GPP) standard. The 4G communication may be performed in a frequency band of 6 GHz or less and the 5G communication may be performed in a frequency band of 6 GHz or more as well as a frequency band of 6 GHz or less. A THz frequency band may be used in the 6G communication or an artificial intelligence (AI) and the other technologies may be applied, and are not limited to a specific form.

For example, for the 4G communication, the 5G communication, and the 6G communication, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform-spread-OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Furthermore, the communication system 100 may further include a core network. When the communication system 100 supports the 4G communication, the core network may include a serving-gateway (S-GW), a packet data network (PDN)-gateway (P-GW), a mobility management entity (MME), or the like. When the communication system 100 supports the 5G communication, the core network may include a user plane function (UPF), a session management function (SMF), an access and mobility management function (AMF), or the like. Furthermore, as an example, when the communication system 100 supports the 5G communication, the core network may be configured based on a function based on the 5G communication or a new function and may not be limited to a specific form.

Meanwhile, each of the plurality of communication nodes 110-1, 110-2, 110-3, 120-1, 120-2, 130-1, 130-2, 130-3, 130-4, 130-5, and 130-6 (or network functions) constituting the communication system 100 may have the following structure.

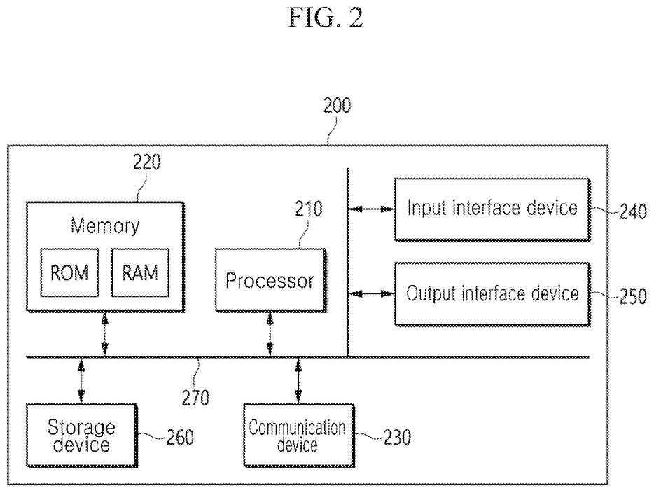

FIG. 2 is a drawing illustrating a device configuration according to an embodiment. Referring to FIG. 2, a communication node 200 (a network function) may include at least one processor 210, a memory 220, and a transceiver 230 connected with a network to perform communication. Furthermore, the communication node 200 may further include an input interface device 240, an output interface device 250, a storage device 260, and the like. The respective components included in the communication node 200 may be connected with each other by a bus 270 to communicate with each other.

However, the respective components included in the communication node 200 may be connected with each other via an individual interface or an individual bus around the processor 210, rather than the common bus 270. For example, the processor 210 may be connected with at least one of the memory 220, the transceiver 230, the input interface device 240, the output interface device 250, and the storage device 260 via a dedicated interface.

The processor 210 may execute a program command stored in at least one of the memory 220 and the storage device 260. The processor 210 may refer to a central processing unit (CPU), a graphics processing unit (GPU), or a dedicated processor in which methods according to embodiments of the present disclosure are performed. Each of the memory 220 and the storage device 260 may be composed of at least one of a volatile storage medium and a non-volatile storage medium. For example, the memory 220 may be composed of at least one of a read only memory (ROM) and a random access memory (RAM).

Referring again to FIG. 1, the communication system 100 may include a plurality of base stations 110-1, 110-2, 110-3, 120-1, and 120-2 and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an “access network”. Each of the first base station 110-1, the second base station 110-2, and the third base station 110-3 may form a macro cell. Each of the fourth base station 120-1 and the fifth base station 120-2 may form a small cell. The fourth base station 120-1, the third terminal 130-3, and the fourth terminal 130-4 may be within cell coverage of the first base station 110-1. The second terminal 130-2, the fourth terminal 130-4, and the fifth terminal 130-5 may be within cell coverage of the second base station 110-2. The fifth base station 120-2, the fourth terminal 130-4, the fifth terminal 130-5, and the sixth terminal 130-6 may be within cell coverage of the third base station 110-3. The first terminal 130-1 may be within cell coverage of the fourth base station 120-1. The sixth terminal 130-6 may be within cell coverage of the fifth base station 120-2.

Herein, each of the plurality of base stations 110-1, 110-2, 110-3, 120-1, and 120-2 may be referred to as NodeB, evolved NodeB, gNB, xNB, a base transceiver station (BTS), a radio base station, a radio transceiver, an access point, an access node, or the like. Each of the plurality of terminals 130-1, 130-2, 130-3, 130-4, 130-5, and 130-6 may be referred to as user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in a different frequency band or may operate in the same frequency band. The plurality of base stations 110-1, 110-2, 110-3, 120-1, and 120-2 may be connected with each other via an ideal backhaul link or a non-ideal backhaul link and may exchange information with each other via the ideal backhaul link or the non-ideal backhaul link. Each of the plurality of base stations 110-1, 110-2, 110-3, 120-1, and 120-2 may be connected with the core network via the ideal backhaul link or the non-ideal backhaul link. Each of the plurality of base stations 110-1, 110-2, 110-3, 120-1, and 120-2 may transmit the signal received from the core network to the corresponding terminals 130-1, 130-2, 130-3, 130-4, 130-5, and 130-6 and may transmit the signal received from the corresponding terminals 130-1, 130-2, 130-3, 130-4, 130-5, and 130-6 to the core network.

Furthermore, as an example, the core network of the communication system 100 may be composed of an architecture based on an interaction between network functions (NFs). As an example, the core network of the 5G system, 5GC, may include various entities. In detail, an access and mobility management function (AMF) may manage access and mobility of the terminal. The AMF may perform non-access stratum (NAS) security management and a mobility management function of the terminal which is in an idle state.

A session management function (SMF) may manage a session. As an example, the SMF may perform a function for allocating a terminal Internet protocol (IP) address and may control a packet data unit (PDU) session.

Furthermore, a policy control function (PCF) may perform a function for controlling a policy. Furthermore, a user plane function (UPF) for performing a function for controlling a user plane may be included. The UPF may be a function of a gateway for transmitting and receiving data, which may perform all or some of user plane functions of a serving gateway (S-GW) and a packet data network gateway (P-GW) of the previous mobile communication system (4G). Furthermore, the UPF may perform a function for handling the PDU. Furthermore, an application function (AP) for controlling an application function may be included. The AF may be a function for providing the terminal with a plurality of services. Furthermore, unified data management (UDM) for managing unified data may be included. Herein, the UDM may perform a function for managing subscriber information.

Furthermore, as an example, a core network of the next-generation system (e.g., 6G) may be the same type of function as the function of the 5G system to be referred to as the same name or may be composed of a new entity (of function) based on the next-generation system and is not limited to a specific embodiment. However, as described above, the next-generation system may be composed of functions for managing access and mobility of the terminal or managing a session and may be applied to items, which will be described below, in the same manner. However, a description will be given on the basis of the 5G system for convenience of description, but is not limited thereto and may be applied to the next-generation system in the same manner.

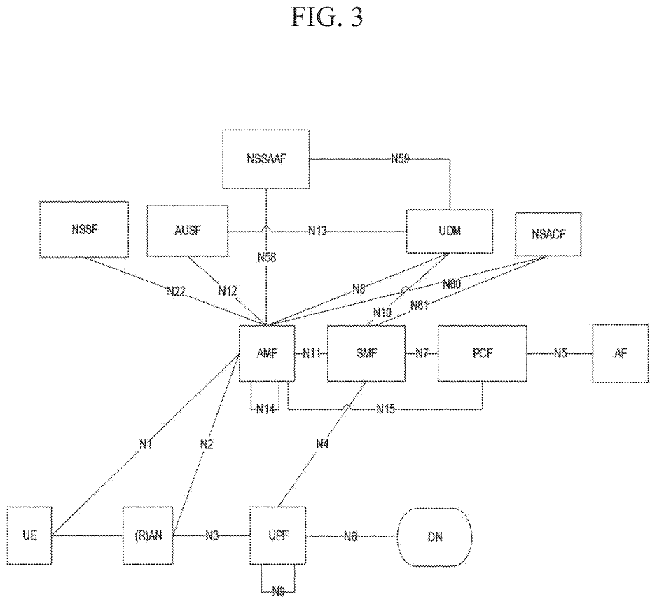

FIG. 3 is a drawing illustrating reference points according to an embodiment of the present disclosure. Referring to FIG. 3, the reference point may indicate an interaction between network function (NF) services in NFs described by the point-to-point reference point between two NFs. As an example, N1 may be a reference point between a UE and an access management function (AMF). N2 may be a reference point between an (R)AN and the AMF. N3 may be a reference point between the (R)AN and a user plane function (UPF).

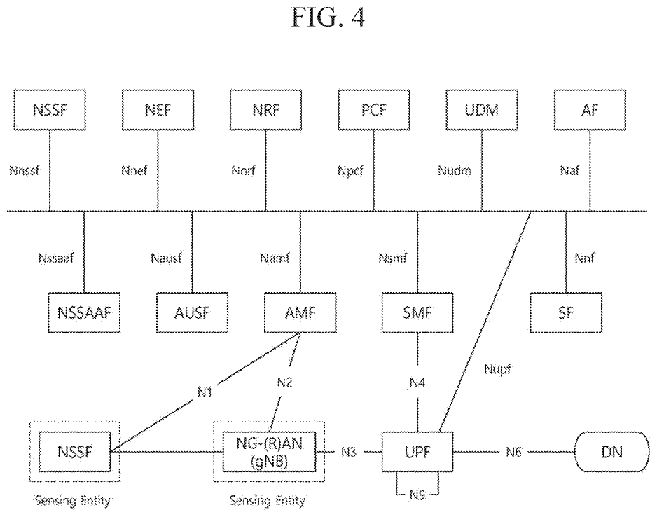

FIG. 4 is a drawing illustrating a system architecture including an NF supporting an integrated sensing and communications function applied to the present disclosure.

Referring to FIG. 4, a network may have a structure in which network functions (NFs) of a control plane are connected with each other via a service based interface (SBI). As an example, the NFs may be connected with each other based on the SBI. This may be similar to FIG. 3. Herein, entities for supporting an integrated sensing and integrated function using integrated sensing and communications (ISAC) may be connected with a network to operate. The ISAC may be a technology for fusing communication and sensing into one integrated platform. In other words, the ISAC may be a technology in which data transmission and reception and radar based object sensing are performed based on one platform based on a communication system. The ISAC may perform communication and sensing at the same time based on the same frequency resource. As an example, a user terminal and a base station may be a sensing entity for performing an ISAC function. The user terminal and the base station, which are the sensing entity, may deliver data to a counterpart using a wireless signal and may simultaneously analyze a reflected wave reflected and returned from a surrounding object or environment to sense a position, a movement speed, a direction, and a form of a target. In FIG. 4, user equipment (UE) and NG-(R)AN (gNB) may be sensing entities. Herein, a network structure for the above-mentioned entity may be required. For those described above, a sensing function (SF) may be considered as a network function for the ISAC in FIG. 4. The SF may be a network function for controlling an operation and a function necessary for sensing entities to perform a sensing operation in conjunction with the ISAC. A description will be given below of a detailed operation.

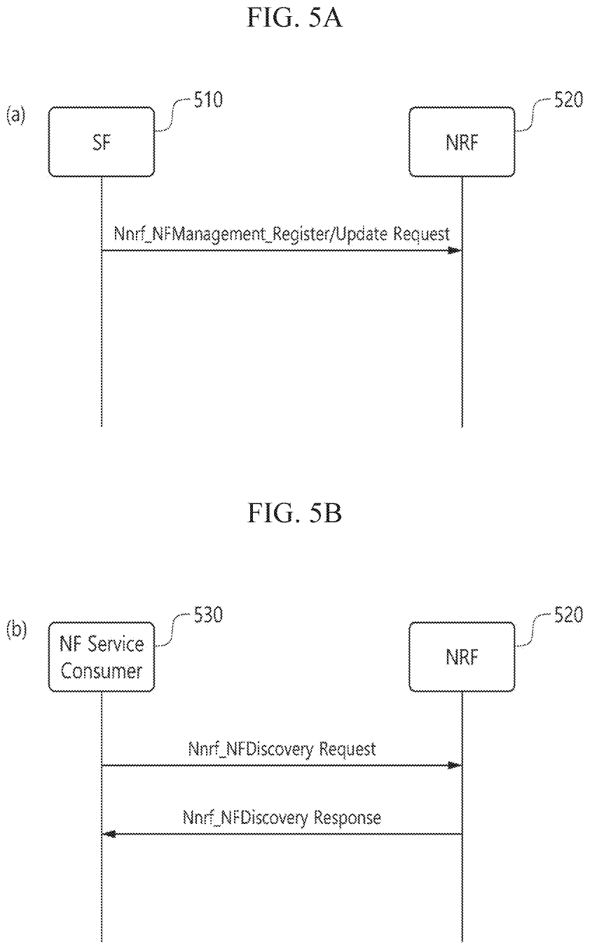

FIGS. 5A and 5B are drawings illustrating a method for registering and requesting an NF profile from an NRF in an SF applied to the present disclosure.

Referring to FIG. 5A, an SF 510 may register a sensing-related NF profile to a network repository function (NRF) 520. The NRF 520 may manage instance (or NF profile) information of a network function and may support mutual discovery. As an example, NFs may be dynamically added or removed based on the NRF 520 in the SBI environment of FIG. 4, which are described above, and an NF profile for the SF 510 may also be registered to the NRF 520. In the NRF 520, an NF registration procedure may be performed as in FIG. 5A and an NF discovery procedure may be performed as in FIG. 5B. As an example, the SF 510 may register the NF profile to the NRF 520 and the NF profile registered by the SF 510 may be the same as Table 1 below and may not be limited thereto. In other words, the SF 510 may register a function and an operation for a service associated with sensing to the NRF 520.

In detail, an SF for performing a sensing function in a wireless communication system may include a plurality of pieces of identification information and a plurality of parameters to provide various sensing services. SFId may be an identifier for uniquely identifying a corresponding SF. servingSensingTargetTypes may be information for defining a type of a sensing target supported by the SF. The sensing target may include an object, a terminal, or the other various types of targets. Furthermore, servingAccessTypes may indicate an access type in which the SF is able to provide a sensing service. As an example, the access type may be, but is not limited to, the above-mentioned SBI or another type of access type. servingAnNodeTypes may be a node type capable of providing a sensing service using a sensing entity. servingRatTypes may indicate an RAT type of a radio access technology, such as 5G or 6G. Furthermore, the SF may check whether there is sensing for any service via servingSensingServiceType. As an example, the service may consider, but is not limited to, a service, such as object detection or autonomous driving. supportAI indicates whether the SF is able to use an artificial intelligence based analysis/inference function in a sensing service processing process. servingSensingModes define a type of a sensing mode supportable by the SF. Furthermore, servingSensingMeasurements may indicate a sensing measurement parameter capable of being collected/reported by the SF. Furthermore, the SF may define a spatial service area capable of respectively sensing a fixed target and a moving target via servingTargetSensingServiceArea and servingMovingTargetSensingServiceArea. servingSensingCapability may indicate a sensing capability provided by the SF. servingSensingExposureInformation may define a type of sensing-related information capable of being exposed to the outside. servingSensingClientTypes may be various client types in which the SF is able to provide the sensing service. The SF may also indicate a current load state via SFLoad and may provide network slice information supportable based on an S-NSSAI and an NSI ID via NetworkSlicingInfo. SFLocation may indicate geographical location information of the SF. Furthermore, servingSensingProtocol and servingUserPlaneSensingProtocol may define a sensing-related protocol supported by the SF. servingSensingCapabilities may be, but is not limited to capabilities for the sensing function supportable by the SF.

TABLE 1

| Attribute name | Description |
|---|---|
| SfId | Identification of SF |
| servingSensingTargetTypes | List Sensing Target Types capable of supporting |
| | service in SF |
| | (Type: Area, Object, UE, Vehicles, UAV, Humans, etc.) |
| servingAccessTypes | Access Types capable of supporting service in SF |
| | (Type: 3GPP_ACCESS and/or NON_3GPP_ACCESS) |
| servingAnNodeTypes | Access Node Types capable of supporting service |
| | in SF (Type: gNB or NG-eNB) |
| servingRatTypes | RAT (Radio Access Technology) Types capable of |
| | supporting service in SF |
| | (Type: 5G NR, 6G NR, eLTE, etc.) |
| servingSensingServiceType | List Sensing Service Types capable of supporting |
| | service in SF |
| | (Type: Object and intruder detection for smart home, |
| | Collision avoidance and trajectory tracking of UAVs/ |
| | vehicles/AGVs, Automotive maneuvering and |
| | navigation, Public safety search and rescue, Rainfall |
| | monitoring and flooding, Health and sports monitoring, |
| | etc.) |
| supportAI | Whether to support service by AI |
| servingSensingModes | List Sensing mode types capable of supporting service in |
| | SF |
| | (Type: gNB mono-static, gNB bi-static, UE to gNB bi- |
| | static, gNB to UE bi-static, UE mono-static, UE bi-static, |
| | etc.) |
| servingSensingMeasurements | Sensing measurement parameters capable of being |
| | supported and reported by SF |
| | (Type: Time of Arrival, Time Difference of Arrival, Rx- |
| | Tx timing difference, Angle of Arrival, Angle of |
| | Departure, Reference Signal Receive Power, Time |
| | Stamp, Doppler information, Confidence, etc.) |
| servingTargetSensingServiceArea | Area where SF is able to sense fixed target |
| servingMovingTargetSensingServiceArea | Area where SF is able to sense moving target |
| servingSensingCapability | Sensing Capability supportable by SF |
| servingSensingExposureInformation | Exposure sensing information supportable by SF |
| servingTransparentSensing | Whether to support function (Transparent Sensing) |
| | capable of analyzing non-3GPP sensing data (LiDAR, |
| | Camera, WiFi-Sensing, etc.), as well as 3GPP sensing |
| | data in SF, combining and analyzing sensing data and |
| | non-3GPP sensing data, and providing the outside with |
| | transparent sensing information service and define relate |
| | parameters |
| servingSensingClientTypes | Sensing service client type supported by SF Emergency |
| | Services |
| | Lawful intercept services |
| | Regulatory Services |
| | Value Added Services |
| | PLMN Operator Services |
| | User-Initiated Services |
| | Enterprise Services |
| SFLoad | Current load information of SF |
| NetworkSlicingInfo | Network slicing information supported by SF. S-NSSAI |
| | and/or NSI ID |
| SFLocation | When selecting geographical location information of SF |
| | and SF geographically close to sensing entities, sensing |
| | service has faster response and increased sensing |
| | accuracy. It is possible to use multiple SFs. |
| servingPerformanceRequirements | Performance Requirements supportable by SF: |
| | Accuracy of Positioning Estimate |
| | Accuracy of velocity estimate |
| | Confidence level |
| | Missed detection probability |
| | False alarm probability |
| | Max sensing service latency |
| | Refreshing rate |
| servingSensingProtocol | — |
| servingUserPlaneSensingProtocol | Support User Plane Sensing Protocol |
| servingSensingCapabilities | — |
| . . . | . . . |

Furthermore, referring to FIG. 5B, an NF service consumer 530 may transmit an NF discovery request for SF discovery and selection to the NRF 520 and may receive a response to it. The NF service consumer 530 may be an NF which requests to select and sense a specific SF in conjunction with the ISAC operation. As an example, each of the SFs may include an SF ID. At least any one of sensing target types, access types, access node types, sensing service types, support AI, sensing modes, sensing measurements, a target sensing service area, a moving target sensing service area, sensing exposure information, transparent sensing, sensing client types, an SF load, network slice information, an SF location, performance requirements, a serving sensing protocol, a serving user plane sensing protocol, and serving sensing capabilities, which are supported for each SF, may be differently set and may be an item below. This may refer to Table 1. In other words, a function for sensing may be differently supported for each SF. The NF service consumer 530 may perform the SF selection procedure of FIG. 5B to select an appropriate SF for the ISAC operation.

### SF Selection Functionality

SF ID
Sensing Target Types
Access Types
Access Node Types
RAT Types
Sensing Service Types
Support AI
Sensing Modes
Sensing Measurements
Target Sensing Service Area
Moving Target Sensing Service Area
Sensing Exposure Information
Transparent Sensing
Sensing Client Types
SF Load
Network Slicing Information
SF Location
Performance Requirements
servingSensingProtocol
servingUserPlaneSensingProtocol
servingSensingCapabilities

Furthermore, information of user equipment (UE) associated with a sensing operation may be obtained from an NF and user data management (UDM). As an example, subscription information of the UE, which is provided from the UDM, may be the same as Table 2 below. Referring to Table 2, subscriber information provided to the NF based on the UDM may include priority information of the UE having an ISAC function in conjunction with ISAC and capability information of the UE. In other words, the subscription information about the UE may include whether the UE supports the ISAC function and priority information based on it. As a result, the NF may obtain ISAC-related information of the UE. In detail, the NF may request UE subscription information from the UDM. The information may include, but is not limited to, whether the UE supports the ISAC function and priority information of the UE like Table 2 below. In other words, whether the UE is able to become a sensing entity capable of performing the ISAC function and priority information about it may be provided as the UE subscription information. When the ISAC operation is performed based on the SF selected via the above-mentioned information, a specific sensing entity among a plurality of sensing entities may be selected.

TABLE 2

| Attribute name | Description |
|---|---|
| internalGroupIds | List of internal group identifier; see 3GPP |
| | TS 23.501 [2] clause 5.9.7 |
| sharedVnGroupDataIds | A map of identifiers of shared 5G VN group |
| | data (list of key-value pairs where a string |
| | in the format of GroupId serves as key; see |
| | clause 6.1.6.1). (NOTE 8) |
| hssGroupId | Identity of the HSS group associated with the |
| | subscription, which may be used by the UDM |
| | in discovering the HSS; see 3GPP TS 29.510 |
| | [19]. |
| subscribedUeAmbr | |
| Nssai | Network Slice Selection Assistance Information |
| ISACUePriority | Priority of UE having integrated sensing and |
| | communications (ISA) function |
| ueISACCapabilities | Whether UE supports ISAC and ISAC |
| | information of UE |
| . . . | . . . |

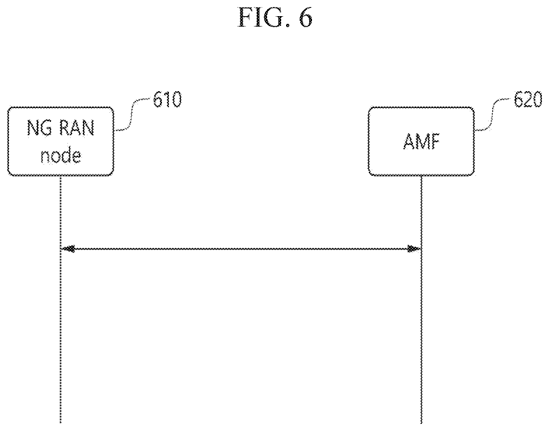

FIG. 6 is a drawing illustrating a terminal information exchange procedure between an NG-RAN node including ISAC information and an AMF applied to the present disclosure. Referring to FIG. 6, an NG-RAN node 610 may deliver terminal-related information to an AMF 620. This may be the same as Table 3. Herein, the terminal-related information may further include ISAC-related information. As an example, the terminal-related information may include radio capability-related information of ISAC. Furthermore, the terminal-related information may further include frequency information considering an ISAC operation or the other signal-related capability information of ISAC and is not limited to a specific form. In other words, the NG-RAN node 610 or a base station may deliver the terminal-related information to the AMF 620. The terminal-related information delivered by the NG-RAN node 610 may further include information about ISAC. Herein, a terminal (or UE) may be a sensing entity, which may perform an ISAC operation. Information about an ISAC radio capability of the terminal considering it may be required. The base station may deliver corresponding information together while delivering the terminal-related information to the AMF 620.

TABLE 3

| IE name | Description |
|---|---|
| Message Type | Message Type |
| 5G-S-TMSI | 5G-S-TMSI |
| NB-IoT UE Priority | NB-IoT UE Priority |
| S-NSSAI | S-NSSAI |
| Allowed NSSAI | Allowed NSSAI |
| UE Radio Capability | NR, MR-DC, E-UTRA radio capabilities |
| | nR-integrated sensing and communications |
| | (ISAC) radio |
| ISAC Radio | nR-integrated sensing and communications |
| | (ISAC) radio |
| Capability | capability |
| . . . | . . . |

Furthermore, the NG-RAN node 610 and the AMF 620 may perform an NG setup and may update a RAN setup. Herein, at least any one of an NG setup procedure and a RAN setup procedure may include ISAC-related information. The ISAC-related information may be the same as Table 4. As an example, at least any one of the NG setup procedure and the RAN setup procedure may include, but is not limited to, at least any one of RAT information, ISAC function information, and ISAC radio capability information. In other words, the NG-RAN node 610 and the AMF 620 may exchange ISAC-related information in the process of performing the mutual setup, but may not be limited thereto.

TABLE 4

| IE name | Description |
|---|---|
| AMF UE NGAP | AMF UE NGAP ID |
| ID | |
| RAN UE NGAP | RAN UE NGAP ID |
| ID | |
| UE Radio | NR, MR-DC, E-UTRA radio capabilities |
| Capability | |
| ISAC Radio | nR-integrated sensing and communications (ISAC) |
| | radio |
| Capability | capability |
| . . . | . . . |

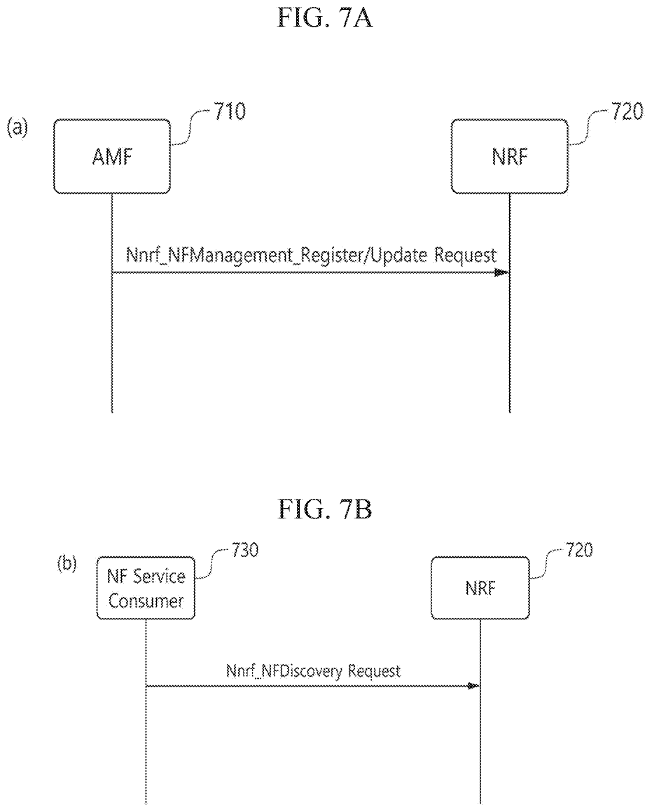

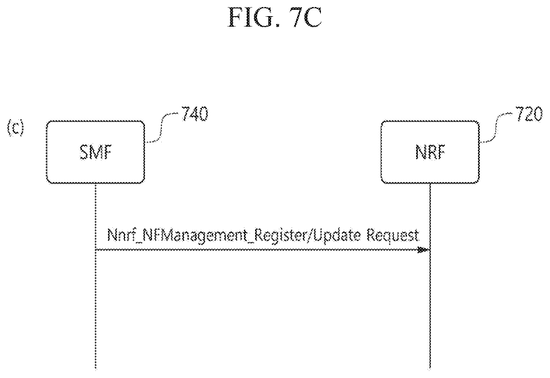

FIGS. 7A to 7C are drawings illustrating an operation between network functions applied to the present disclosure. Referring to FIG. 7A, FIG. 7A is a drawing illustrating a method for performing registration to an NRF 720 in an AMF 710. Referring to FIG. 7A, the AMF 710 may perform a procedure (NF Register) of registering its NF profile to the NRF 720. The AMF 710 may transmit an NF profile including ISAC function-related information as well as AMF-related information to the NRF 720. The NRF 720 may store information received from the AMF 710 and may recognize and manage that the AMF 710 is a node capable of providing a sensing service.

Referring to FIG. 7B, another NF as an NF service consumer 730 may transmit an NF discovery request to the NRF 720 for a communication service. Herein, when having to select an AMF for the communication service, the NF service consumer 730 may request the NRF 720 to search for a target AMF. As an example, when the service is an ISAC-related service and it is necessary to support an ISAC function, there is a need to check whether the AMF supports a sensing function when the NF service consumer 730 performs a function of selection the AMF (AMF selection functionality) (support sensing). In other words, when the service requires the sensing function based on the ISAC function, the NF service consumer 730 may set a parameter for support sensing as a condition when transmitting a query to the NRF 720 and the NRF 720 may provide a list of AMFs which support the ISAC function among registered AMFs as a response. Via those described above, the NF service consumer 730 may select the AMF supporting the ISAC function to exchange a communication and sensing control message and may provide an ISAC-related service.

Furthermore, referring to FIG. 7C, a session management function (SMF) 740 may be registered to the NRF 720. Herein, information used when the SMF 740 is registered to the NRF 720 may be smfInfo and may be the same as Table 5 below, but may not be limited thereto. As an example, smfInfo may include information based on an existing network and may further an servingSensing attribute. A servingSensing field may be information indicating whether the SMF supports the ISAC function. in other words, the SMF 740 loading the ISAC function may configure smfInfo including servingSensing information of Table 5 and may transmit an NF register request (NF Register) to the NRF 720. Herein, the NRF 720 may recognize that the SMF supports the ISAC function and may manage information about it. Furthermore, support sensing may be considered in the process (SMF Selection Functionality) of selecting the SMF in another NF as an NF service consumer. As an example, when it is necessary to provide the ISAC-related service, the NF service consumer may search for an SMF in which the servingSensing attribute is set via the NRF and may obtain information about the SMF supporting the ISAC function.

TABLE 5

| Attribute name | Description |
|---|---|
| sNssaiSmfInfoList | List of parameters supported by the SMF per |
| | S-NSSAI |
| taiList | The list of TAIs the SMF can serve. It may |
| | contain one or more non-3GPP access TAIs. |
| pgwFqdn | The FQDN of the PGW if the SMF is a combined |
| | SMF/PGW-C. |
| vsmfSupportInd | This IE may be used by an SMF to explicitly |
| | indicate the support of V-SMF capability and |
| | its preference to be selected as V-SMF. |
| servingSensing | Integrated sensing and communications (ISAC) |
| | function support information |
| . . . | . . . |

Furthermore, upfInfo used when a user plane function (UPF) is registered to the NRF may be considered. As an example, the UPF may add the servingSensing attribute to upfInfo including information of the UPF. In other words, upfInfo may further include servingSensing attribute information in addition to information associated with an existing wireless communication system. This may be the same as Table 6. Herein, the servingSensing attribute may include an ISAC support feature. Furthermore, upfInfo may further include a supportedPfcpFeatures attribute and as a result, may specify whether to support detailed UPF features. In other words, upfInfo may further include pieces of information associated with the ISAC function. The NRF may recognize a UPF supporting the ISAC function via those described above. Furthermore, Table 7 may be a list of its UP function features provided to the NRF or the SMF by the UPF. Referring to Table 7, the list of the function features of the UPF may further include an ISAC feature as well as information associated with the existing wireless communication system. As an example, the ISAC feature may mean that the UPF supports the ISAC function and it is possible to process and transmit a packet of sensing data. In other words, its UP function features provided to the NRF or the SMF by the UPF may include a new attribute associated with ISAC. As a result, the UPF may support the ISAC function to indicate that it is possible to process and transmit the packet of the sensing data.

TABLE 6

| Attribute name | Description |
|---|---|
| SNssaiUpfInfoList | List of parameters supported by the UPF per |
| | S-NSSAI (NOTE 1) |
| SmfServingArea | The SMF service area(s) the UPF can serve. |
| | If not provided, the UPF can serve any SMF |
| | service area. |
| InterfaceUpfInfoList | List of User Plane interfaces configured on |
| | the UPF. When this IE is provided in the NF |
| | Discovery response, the NF Service Consumer |
| | (e.g. SMF) may use this information for |
| | UPF selection. (NOTE 7) |
| a2xSupportInd | Indicates whether A2X Policy/Parameter |
| | provisioning is supported by the PCF. |
| ServingSensing | Integrated sensing and communications (ISAC) |
| | function support information |
| supportedPfcpFeatures | UP Function Features including ISAC support |
| | function |
| . . . | . . . |

TABLE 7

| Feature | Description |
|---|---|
| BUCP | Downlink Data Buffering in CP function is supported |
| | by the UP function. |
| DDND | The buffering parameter ‘Downlink Data Notification |
| | Delay’ is supported by the UP function. |
| DLBD | The buffering parameter ‘DL Buffering Duration’ |
| | in PFCP Session Report Response is supported |
| | by the UP function. |
| TRST | Traffic Steering is supported by the UP function. |
| FTUP | F-TEID allocation/release in the UP function is |
| | supported by the UP function. |
| PFDM | The PFD Management procedure is supported by the UP |
| | function. |
| HEEU | Header Enrichment of Uplink traffic is supported by |
| | the UP function. |
| TREU | Traffic Redirection Enforcement in the UP function |
| | is supported by the UP function. |
| ISAC | Integrated sensing and communications (ISAC) |
| | function support information |
| . . . | . . . |

Furthermore, when the UPF is registered to the NRF, it may generate and register a profile including servingSensing information and ISAC Feature information to the NRF. Via those described above, the NRF may be instructed that it may be used as a user plane node capable of processing sensing data. Furthermore, an NF service consumer as another NF may perform UPF selection for searching for a UPF including a feature supporting the ISAC function in the NRF. As an example, the NF service consumer as another network function may perform a function of selecting the UPF (UPF Selection Functionality) to set a user data path. Herein, because UPF selection supporting the ISAC function is able to be required when the service is an ISAC-related service, the above-mentioned support sensing may be used. As an example, the SMF may obtain a list of UPFs for transmitting a query to the NRF to support an ISAC feature and may select an optimal UPF capable of processing sensing data traffic based on it.

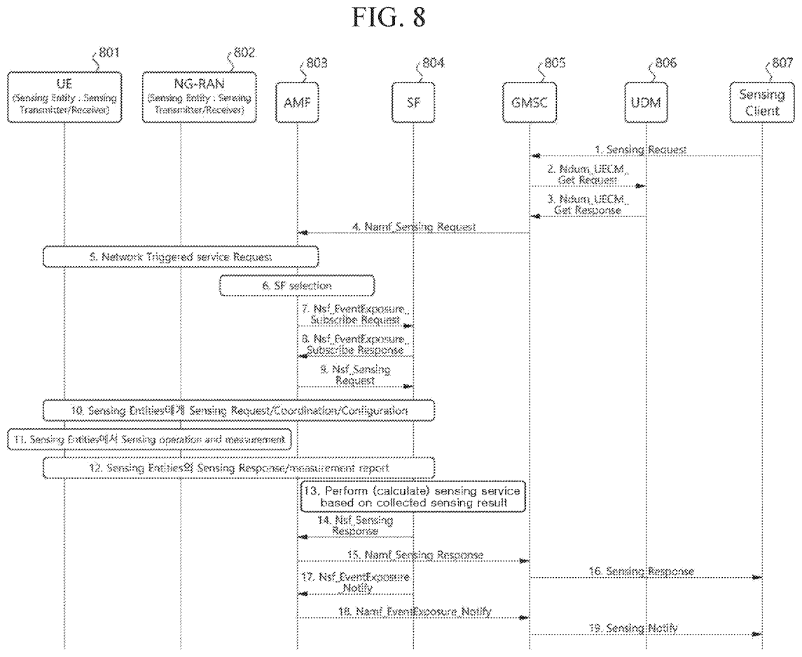

Next, a structure further including a gateway mobile sensing center (GMSC) may be considered in FIG. 4. AS an example, the GMSC may be connected with an SBI via Ngmsc and may be connected with other NFs. A sensing client may be connected with the GMSC. As an example, the GMSC may obtain and provide data sensed in a network to the sensing client. In detail, there may be a limitation in which a base station processes ISAC-related sensing data alone. The GMSC may be considered as a data center for it. Furthermore, the GMSC may generate sensing data obtained from the network via the SBI as available information via processing of the sensing data and is not limited to a specific form. FIGS. 8 to 12 below may be, but is not limited to, an operation based on the above-mentioned GMSC.

FIG. 8 is a drawing illustrating a GMSC based sensing service providing procedure applied to the present disclosure. Referring to FIG. 8, a sensing client 807 may transmit a Sensing Request message to a GMSC 805 to request a specific sensing service. A Sensing Request may include at least any one of a client ID, a type and purpose of a requested sensing service, SUPIs or GPSIs of target UEs, a sensing group composed of one or more UEs, a sensing service area where sensing should be performed, a time period for sensing, and QoS requirements, such as accuracy of positioning estimate, accuracy of velocity estimate, a confidence level, a missed detection probability, a false alarm probability, max sensing service latency, and a refreshing rate. The GMSC 805 may deliver an Nudm_UECM_Get message including the request information received from the sensing client 807 to a UDM 806. The UDM 806 may search for a network address of an AMF 803 in which UEs are currently accommodated, which is requested based on information, such as the client ID, the purpose of sensing, the QoS requirements, or the SUPIs or GPSIs of the target UEs, which are provided by the GMSC 805. Thereafter, the UDM 806 may return the network address of the AMF to the GMSC 805 as an Nudm_UECM_Get response. The GMSC 805 may transmit an Namf_Sensing Request message including the information requested by the sensing client 807 (e.g., the sensing service type, purpose of sensing, the UE information, the QoS requirements, the sensing group, the sensing report description, and the like), to the AMF 803 using the network address of the AMF 803, which is identified from the UDM 806. When a target UE 801 is in a CM IDLE state and there is no UE unaware indication, the AMF 803 may perform a network triggered Service Request procedure to establish a signaling connection with the UE. Thereafter, the AMF 803 may select a sensing function (SF) 804 based on a local configuration and an element which should be considered when the NF selects an SF. The AMF 803 may request Sensing Event Notify Subscribe including a notification target address, an event ID, an event type, a report type, and the like using an Nsf_EventExposure_Subscribe Request from the selected SF 804. The SF 804 may respond to it as an Nsf_EventExposure_Subscribe Response.

Next, the AMF 803 may deliver an Nsf_Sensing Request message including the entire request information of the sensing client 807 to the SF 804. The SF 804 may select one or more sensing entities (e.g., gNB, a RAN node, an NTN node, a cooperative node, and the like) 801 and 802 and may exchange a sensing request, sensing coordination, and sensing configuration with the selected sensing entities 801 and 802. The selected sensing entities 801 and 802 may perform a sensing operation and sensing measurement depending on the configuration provided from the SF 804. The result of performing the measurement (the sensing measurement report or the sensing response) may be delivered to the SF 804 via the AMF 803. The SF 804 may calculate a sensing result based on the sensing measurement data collected from the sensing entities 801 and 802. Herein, the calculated sensing result may include at least any one of a service result, position information of a target, a velocity, a range, an angle, confidence, environmental information (geometric information, map information, and contextual information), a UE ID, sensing service latency, sensing assistance information, and QoS requirements (accuracy of positioning estimate, accuracy of velocity estimate, a false alarm probability, and the like). The SF 804 may deliver the sensed information to the AMF 803. The AMF 803 may deliver an Namf_Sensing Response message to the GMSC 805. The GMS 805 may deliver it to the sensing client 807 in the form of a sensing response.

As an example, when the sensing result is delivered based on a periodical report, a delay report, or an event-triggered report, the SF 804 may transmit the result to the AMF 803 via the Nsf_EventExposure_Notify message. The AMF 803 may convert it into an Namf_EventExposure_Notify message and may provide the GMSC 805 with the Namf_EventExposure_Notify message. Finally, the GMSC 805 may provide the sensing client 807 with a Sensing Notify message. As described above, in FIG. 8, the request of the sensing client 807 may be delivered to the UDM 806 and the AMF 803 via the GMSC 805 and the sensing result performed by the selected SF 804 and the sensing entities 801 and 802 may be reported to the sensing client 807 again via the GMSC 805. As a result, the GMSC based ISAC service may be provided.

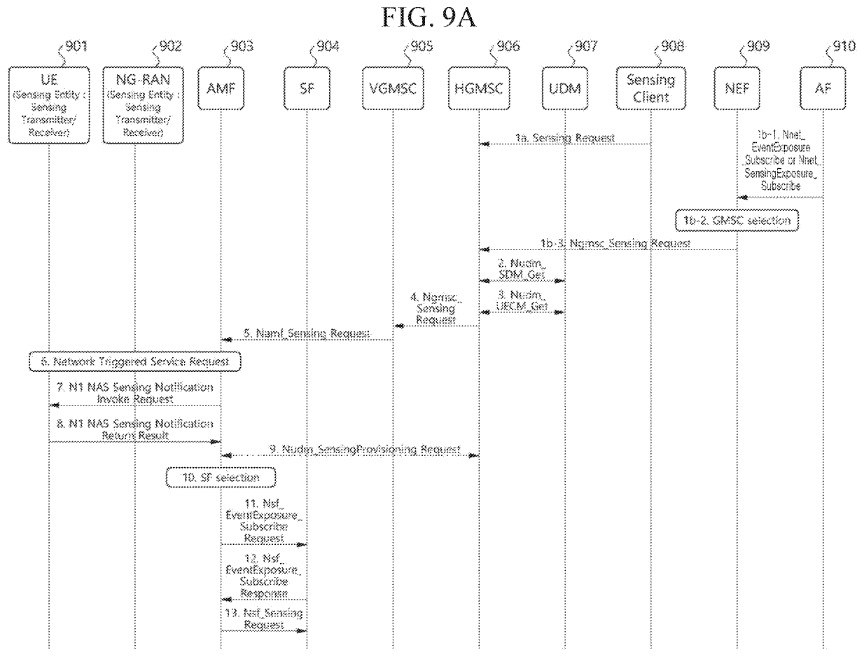

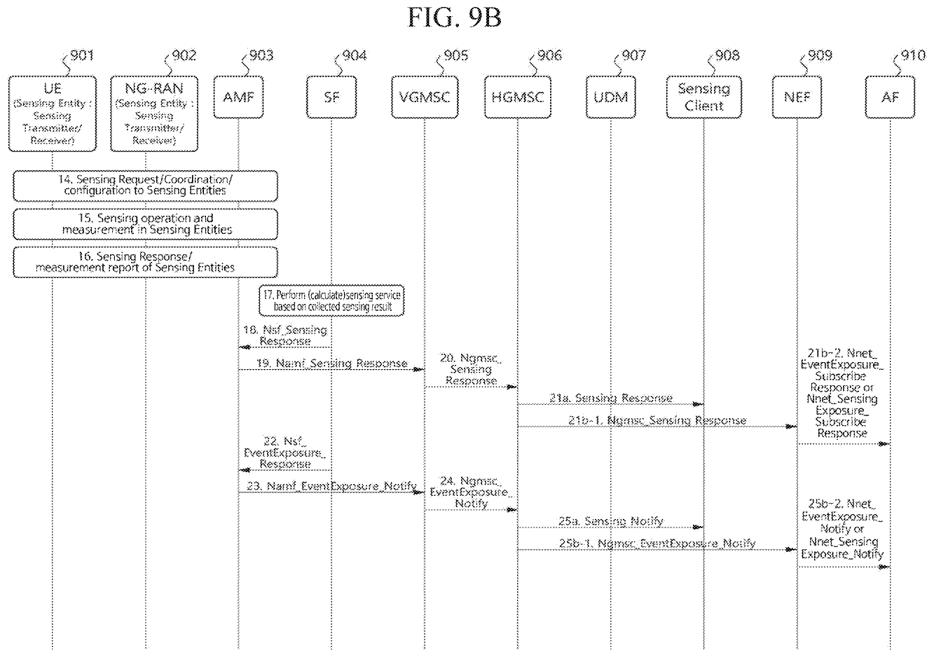

FIG. 9A and FIG. 9B are drawings illustrating a GMSC based expansion sensing service providing procedure applied to the present disclosure. Referring to FIGS. 9A and 9B, a sensing client 908 may deliver a Sensing Request message to be delivered to a GMSC to an AF 910 or an HGMSC 906 directly to request a specific sensing service. A Sensing Request may include at least any one of a client ID, a sensing service type, purpose of sensing, SUPIs or GPSIs of target UEs, a sensing group, a sensing service area, a time period for sensing, QoS requirements, such as accuracy of positioning and velocity estimate, a confidence level, a missed detection probability, a false alarm probability, max sensing service latency, and a refreshing rate, a sensing report description, and a response type immediate/isolated/periodical/event-triggered). The AF 910 may transmit an Nnef_EventExposure_Subscribe or Nnef_SensingExposure_Subscribe message including an AF ID, a sensing event type, a notification target address, an event ID, an event type, a report type, and the like in addition to the above-mentioned request information to an NEF 909. The NEF 909 may identify a network address of an appropriate GMSC based on the client ID, the purpose of sensing, the sensing event type, the QoS requirements, and the like provided from the AF 910. This information may be obtained via a local configuration or an NRF query. The HGMSC 906 may transmit an Nudm_SDM_Get message including the above-mentioned request information to a UDM 907 to perform sensing privacy check for a UE 901 and sensing service authorization of the AF 910. Next, the HGMSC 906 may deliver an Nudm_UECM_Get message to the UDM 907 to search for a network address of an AMF 903 or a network address of a VGMSC 905 in a roaming environment. When there is roaming, the HGMSC 906 may first deliver a detailed sensing request to the VGMSC 905 as an Ngmsc_SensingRequest message. The VGMSC 905 may deliver an Namf_SensingRequest message including the request information to the AMF 903. When there is no roaming, the HGMSC 906 may directly provide the AMF 903 with the Namf_SensingRequest message. When a target UE is in a CM-IDLE state and does not have UE unaware indication, the AMF 903 may perform a network triggered Service Request procedure to establish a signaling connection with the UE 901. Furthermore, the AMF 903 may deliver an N1 NAS Sensing Notification Invoke Request for performing Sensing Privacy Notification Verification to the UE 901. The UE 901 may transmit a Sensing Notification Return Result corresponding to it to the AMF 903. The AMF 903 may deliver a Privacy Notification Verification Result to the UDM 907 in the form of a Nudm_SensingProvisioning Request to update privacy data. The AMF 903 may select an appropriate SF 904 based on the local configuration or the above-mentioned NF selection criteria and may deliver an Nsf_EventExposure_Subscribe message including at least any one of a notification target address, an event ID, an event type, and a report type to the SF 904 to request Sensing Event Notify Subscribe from the SF 904. The SF 904 may respond to it as an Nsf_EventExposure_Subscribe Response.

Thereafter, the AMF 903 may deliver an Nsf_SensingRequest message including at least any one of an AF ID, a client ID, purpose of sensing, an identifier of a target UE, QoS requirements, a sensing group, a sensing report description, a response type, and a sensing event type to the SF 904. The SF 904 may select one or more sensing entities 901 and 902 based on the received request information and may exchange a sensing request, sensing coordination, and a sensing configuration with them. Such exchanging may be performed using Namf_Communication_N1N2MessageTransfer or an N1/N2 message. Furthermore, the selected sensing entities 901 and 902 may perform a sensing operation and measurements depending to the configuration provided from the SF 904. The measured sensing response or sensing measurement report may be delivered to the SF 904. The process may also be performed via Namf_Communication_N1N2MessageTransfer or the N1/N2 message passing through the AMF 903. The SF 904 may calculate a sensing result based on the collected measurement data. The result may include at least any one of a service result, position information, a velocity, a range, an angle, confidence, geometric information, map information, contextual information, a UE ID, sensing service latency, sensing assistance information, accuracy of positioning estimate, accuracy of velocity estimate, a missed detection probability, and a false alarm probability. A value requiring an immediate report in the calculated result may be provided to the AMF 903 via an Nsf_SensingResponse message. Furthermore, the AMF 903 may deliver a sensing response to the VGMSC 905 or the HGMSC 906 as an Namf_SensingResponse message depending to whether there is roaming. When there is the roaming, the VGMSC 905 may deliver an Ngmsc_SensingResponse message to the HGMSC 906. The HGMSC 906 provide the sensing client 908 with it in the form of a sensing response. Meanwhile, the VGMSC 905 may deliver the sensing response to an NEF 909. The NEF 909 may retransmit a corresponding value to the AF 910 as an EventExposure or SensingExposure Response.

Furthermore, the SF 904 may provide the AMF 903 with a sensing result which should be reported in an event-triggered, periodic, or delay manner as an Nsf_EventExposure_Notify message. The AMF 903 may deliver it to the VGMSC 905 or the HGMSC 906 as an Namf_EventExposure_Notify message depending on whether there is roaming. Upon the roaming, the VGMSC 905 may deliver an Ngmsc_EventExposure_Notify message to the HGMSC 906. Thereafter, the HGMSC 906 may provide the sensing client 908 with the value in the form of Sensing Notify and may simultaneously deliver an Ngmsc_EventExposure_Notify message to the NEF 909. The NEF 909 may provide the AF 910 with the event-triggered/period/delay sensing result as an Nnef_EventExposure_Notify or Nnef_SensingExposure_Notify message.

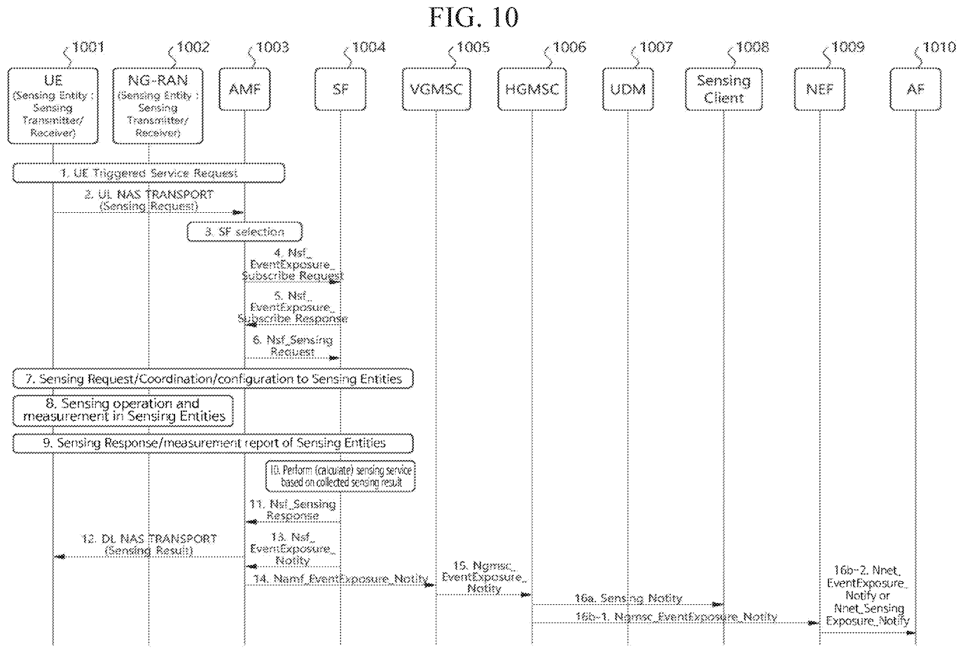

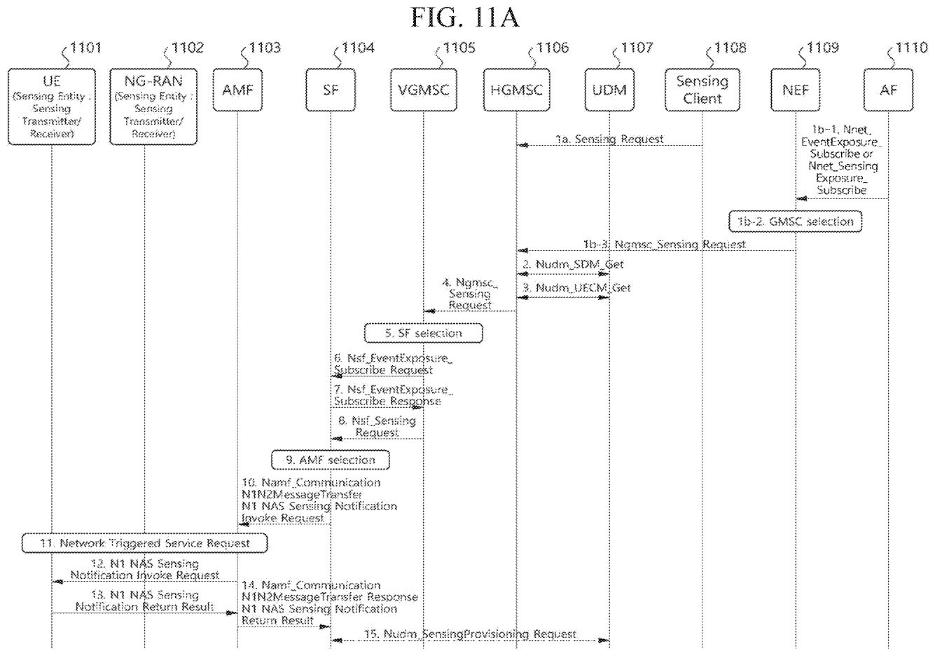

FIG. 10 is a drawing illustrating a UE-AMF direct based sensing service providing procedure applied to the present disclosure. Referring to FIG. 10, when a UE 1001 is in a CM-IDLE state, it may perform a UE triggered Service Request procedure for establishing a signaling connection with an AMF 1003. A sensing client 1008 may transmit a sensing request message to the AMF 1003 via an N1 interface (NAS). Herein, the message may include at least any one of a client ID, a sensing service type, purpose of sensing, SUPIs or GPSIs of UEs, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing a sensing description, and response type rate, report (immediate/isolated/periodical/event-triggered) information.

The AMF 1003 may select an SF 1004 depending on a local configuration or NF selection criteria. Thereafter, the AMF 1003 may transmit an Nsf_EventExposure_Subscribe Request message including at least any one of a notification target address, an event ID, an event type, and a report type to the SF 1004 to request sensing event registration. The SF 1004 may respond to it as an Nsf_EventExposure_Subscribe Response. Thereafter, the AMF 1003 may deliver an Nsf_SensingRequest message including at least any one of the request information (the client ID, the purpose of sensing, the identifiers of the target UEs, the QoS requirements, the sensing group, the sensing report description, the response type, the sensing event type, and the like) delivered from the sensing client 1008 to the SF 1004. The SF 1004 may select one or more sensing entities 1001 and 1002 for performing the requested sensing service and may exchange and set sensing request, sensing coordination, and sensing configuration information for the selected sensing entities. Such information delivery may be performed via Namf_Communication_N1N2MessageTransfer between the SF 1004 and the AMF 1003 or an N1/N2 message among SF-AMF-sensing entity. Herein, the selected sensing entities 1001 and 1002 may perform a sensing operation depending to proceed with sensing measurement, depending on the configured configuration. The sensing measurement result (a sensing response or a sensing measurement report) may be delivered to the SF 1004 via the AMF 1003 or through the N1/N2 message. Namf_Communication_N1N2MessageTransfer may be used. The SF 1004 may generate a sensing result based on the collected sensing measurement data. Herein, the generated sensing result may include at least one or more of service result, position information, velocity, range, angle, confidence, geometric information, map information, contextual information, UE ID, sensing service latency, sensing assistance information, accuracy of positioning estimate, accuracy of velocity estimate, confidence level, missed detection probability, false alarm probability, max sensing service latency, and refreshing rate elements. The sensing result requiring an immediate report may be transmitted to the AMF 1003 as an Nsf_SensingResponse message from the SF 1004. The AMF 1003 may transmit a sensing request message to the UE 1001 based on an N1 interface (NAS) to perform a sensing-related operation. Furthermore, the sensing result to be reported in an event-triggered, periodic, or delay manner may be delivered to the AMF 1003 via an Nsf_EventExposure_Notify message from the SF 1004. The AMF 1003 may deliver an Namf_EventExposure_Notify message to a VGMSC 1005 or an HGMSC 1006 depending on whether there is roaming. In a roaming environment, the VGMSC 1005 may transmit the sensing result to the HGMSC 1006 using an Ngmsc_EventExposure_Notify message. The HGMSC 1006 may provide the sensing client 1008 with the received sensing result in the form of Sensing Notify. The HGMSC 1006 may deliver the sensing result to an NEF 1009 via the Ngmsc_EventExposure_Notify message. The NEF 1009 may provide an AF 1010 with the sensing result using an Nnef_EventExposure_Notify or Nnef_SensingExposure_Notify message. In the entire procedure of FIG. 10, the NAS based sensing request starting from the UE 1001 may be delivered to the SF 1004 and the one or more sensing entities 1001 and 1002 via the AMF 1003. The sensing result performed in the sensing entities 1001 and 1002 may be reported to the sensing client 1008 and the AF 1010 via the AMF 1003 and the HGMSC 1006.

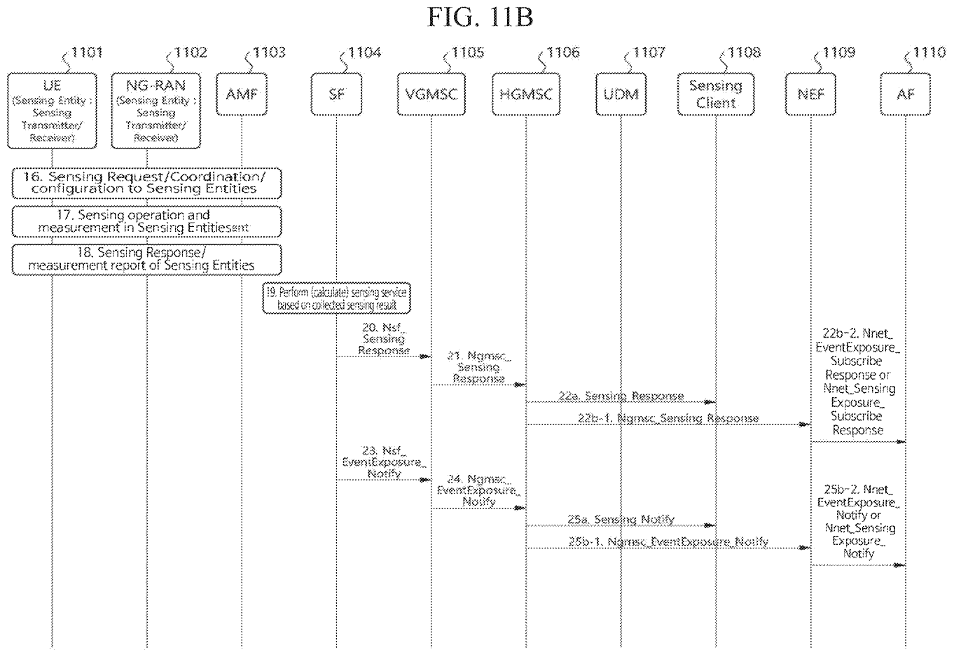

FIGS. 11A and 11B drawings illustrating a GMSC based expansion sensing service providing procedure applied to the present disclosure.

Referring to FIGS. 11A and 11B, a sensing client 1108 may generate a Sensing Request message to be delivered to a GMSC. The message may include at least any one of a client ID, a sensing service type, purpose of sensing, SUPIs or GPSIs of UEs, a sensing group, a sensing service area, a time period for sensing, accuracy of positioning estimate, accuracy of velocity estimate, a confidence level, a missed detection probability, a false alarm probability, max sensing service latency, a refreshing rate, a sensing report rt description, and a response type (immediate/isolated/periodical/event-triggered). An AF 1110 may transmit an Nnef_EventExposure_Subscribe or Nnef_SensingExposure_Subscribe message including at least any one of an AF ID, a notification target address, an event ID, an event type, a report type, and a sensing event type other than the information delivered from the sensing client 1108 to an NEF 1109. The NEF 1109 may analyze request information (a client ID, an AF ID, purpose of sensing, UE information, QoS requirements, and the like) to determine a network address of the GMSC. The information may be obtained via a local configuration or an NRF query.

An HGMSC 1106 may transmit an Nudm_SDM_Get message including the request information to a UDM 1107 to perform privacy and authorization verification for a sensing privacy check and sensing service authorization of the AF 1110. The HGMSC 1106 may transmit an Nudm_UECM_Get message to the UDM 1107 to search for a network address of an AMF 1103 or a network address of a VGMSC 1105 in a roaming environment, which is required to perform a sensing service. In the roaming environment, the HGMSC 1106 may deliver an Ngmsc_SensingRequest message to the VGMSC 1105 to request to perform a full-fledged sensing procedure. The VGMSC 1105 or the HGMSC 1106 may select an SF 1104 based on a local configuration or NF selection criteria. Thereafter, the VGMSC 1105 or the HGMSC 1106 may transmit an Nsf_EventExposure_Subscribe Request message including at least any one of a notification target address, an event ID, an event type, and a report type to the selected SF 1104 to request Sensing Event Notify Subscribe. Thereafter, the SF 1104 may respond as an Nsf_EventExposure_Subscribe Response message. When there is the roaming, the VGMSC 1105 may deliver an Nsf_SensingRequest message to the SF 1104. When there is no roaming, the HGMSC 1106 may provide the SF 1104 with the same message. The SF 1104 may perform an AMF selection process based on a local configuration and NRF or UDM information to select the AMF 1103 supporting a sensing function. The SF 1104 may deliver an N1 Sensing Notification Invoke Request including all pieces of related information (an AF ID, a client ID, purpose of sensing, QoS requirements, a sensing group, and the like) to the AMF 1103 via Namf_Communication_N1N2MessageTransfer to provide a UE 1101 with Sensing Privacy Notification Verification information. When the UE 1101 is in a CM-IDLE state and UE unaware indication is not set, the AMF 1103 may perform a network triggered Service Request procedure defined in TS 23.502 to establish a signaling connection with the UE 1101. The AMF 1103 may deliver a Sensing Privacy Notification Invoke Request to the UE 1101 via an N1 interface (NAS). The UE 1101 may transmit an N1 Sensing Notification Return Result including a Sensing Privacy Notification Verification Response to the AMF 1103. Receiving it, the AMF 1103 may provide the SF 1104 with a Privacy Verification result as an Namf_Communication_N1N2MessageTransfer Response message.

The SF 1104 may deliver an Nudm_SensingProvisioning Request message to the UDM 1107 to request to update privacy data of the UE 1101, based on the Privacy Verification result. The SF 1104 may select one or more sensing entities 1101 and 1102 to perform sensing and may exchange a sensing request, sensing coordination, and a sensing configuration. This process may be performed via Namf_Communication_N1N2MessageTransfer or an N1/N2 message. The selected sensing entities 1101 and 1102 may perform a sensing operation and measurement. The result of performing the measurement (a sensing response or a sensing measurement report) may be delivered to the SF 1104 via the AMF 1103 or through the N1/N2 message. The SF 1104 may calculate a sensing result based on the collected measurement data. The result may include at least any one of position information, a velocity, a range, an angle, confidence, geometric information, map information, contextual information, a UE ID, sensing service latency, sensing assistance information, accuracy of positioning estimate, accuracy of velocity estimate, a missed detection probability, and a false alarm probability. Furthermore, the sensing result requiring an immediate report may be delivered to the VGMSC 1105 upon roaming and may be delivered to the HGMSC 1106 upon no roaming, as an Nsf_SensingResponse message from the SF 1104. In the roaming environment, the VGMSC 1105 may provide the HGMSC 1106 with the result via an Ngmsc_SensingResponse message. The HGMSC 1106 may directly provide the sensing client 1108 with the sensing result. Furthermore, the VGMSC 1105 may deliver the sensing result to an NEF 1109 in the form of Ngmsc_SensingResponse. The NEF 1109 may provide the AF 1110 with it in the form of an Nnef_EventExposure_Subscribe Response or an Nnef_SensingExposure_Subscribe Response. Furthermore, the SF 1104 may deliver the sensing result to the VGMSC 1105 or the HGMSC 1106 as an Nsf_EventExposure_Notify message depending on an event-triggered or periodic/delay condition. In the roaming environment, the VGMSC 1105 may deliver the result to the HGMSC 1106 via an Ngmsc_EventExposure_Notify message. The HGMSC 1106 may provide the sensing client 1108 with a Sensing Notify message and may deliver an Ngmsc_EventExposure_Notify message to the NEF 1109. The NEF 1109 may deliver it to the AF 1110 in the form of an Nnef_EventExposure_Notify or Nnef_SensingExposure_Notify message to complete the event-triggered or periodic/delay sensing result report.

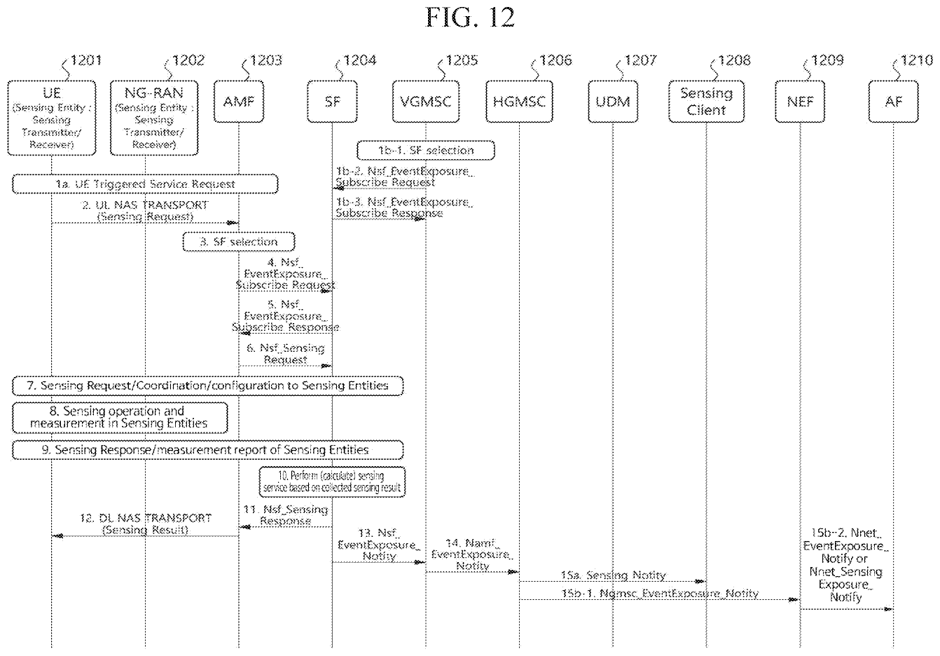

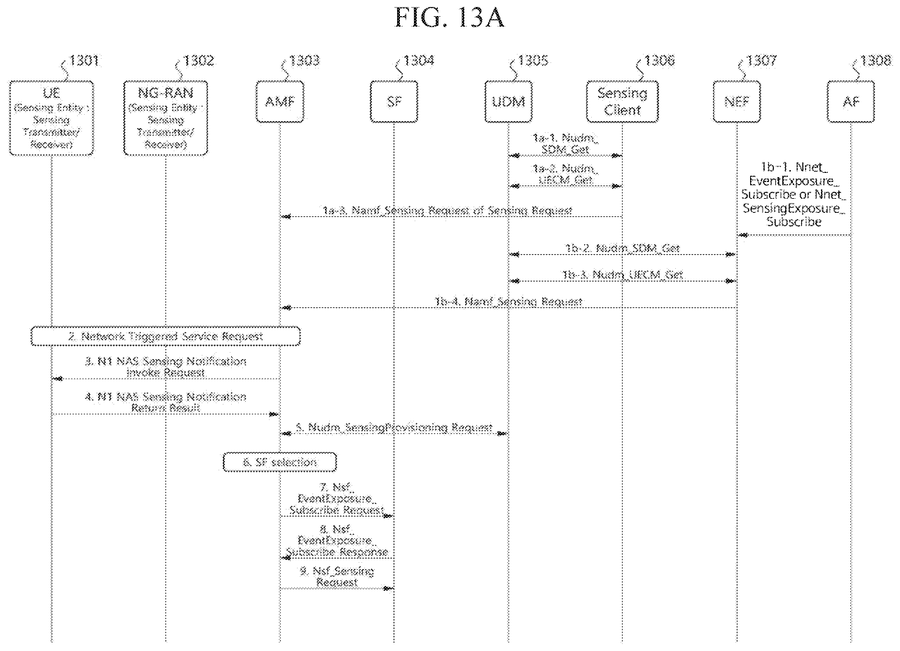

FIG. 12 is a drawing illustrating a GMSC and AMF based mixed sensing service providing procedure applied to the present disclosure. Referring to FIG. 12, when a UE 1201 is in a CM-IDLE state, it may perform a UE triggered Service Request procedure for establishing a signaling connection with an AMF 1203. A GMSC may select an appropriate SF 1204 based on a local configuration or NF selection criteria. In a roaming environment, a VGMSC 1205 may transmit an Nsf_EventExposure_Subscribe Request message including at least any one of a notification target address, an event ID, an event type, and a report type to the SF 1204 to request Sensing Event Notify Subscribe. On the other hand, when there is no roaming, an HGMSC 1206 may deliver an Nsf_EventExposure_Subscribe Request message including the same information to the SF 1204. In the roaming environment, the SF 1204 may respond to the VGMSC 1205 as an Nsf_EventExposure_Subscribe Response message. When there is no roaming, the SF 1204 may respond to the HGMSC 1206 as the Nsf_EventExposure_Subscribe Response. A sensing client 1208 may transmit a Sensing Request message to the AMF 1203 via an N1 interface (NAS). The message may include information of at least any one of a client ID, a sensing service type, purpose of sensing, an SUPI or GPSI of a target UE, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, and a response type. The AMF 1203 may select the appropriate SF 1204 depending on a local configuration or NF selection criteria. Thereafter, the AMF 1203 may transmit an Nsf_EventExposure_Subscribe Request message including at least any one of a notification target address, an event ID, an event type, and a report type to the SF 1204 to request Sensing Event Notify Subscribe. The SF 1204 may respond to the information as an Nsf_EventExposure_Subscribe Response message. Thereafter, the AMF 1203 may deliver an Nsf_SensingRequest message including the request information (the client ID, the purpose of sensing, the UE information, the QoS requirements, the sensing group, the sensing report description, the response type, the sensing event type, and the like) delivered from the sensing client 1208 to the SF 1204. The SF 1204 may select one or more sensing entities 1201 and 1202 and may exchange or set sensing request, sensing coordination, sensing configuration information. Information exchange between the SF 1204 and the AMF 1203 or among SF-AMF-sensing entity may be performed via Namf_Communication_N1N2MessageTransfer or an N1/N2 message. The selected sensing entities 1201 and 1202 may perform a sensing operation and measurement depending on the set condition. The measured sensing response or sensing measurement report may be delivered to the SF 1204 via the AMF 1203 or through the N1/N2 message. Namf_Communication_N1N2MessageTransfer may be used.

The SF 1204 may calculate a sensing result based on the collected measurement result. The calculated sensing result may include at least any one of position information, a velocity, a range, an angle, confidence, geometric information, map information, contextual information, a UE ID, sensing service latency, sensing assistance information, accuracy of positioning estimate, accuracy of velocity estimate, a missed detection probability, and a false alarm probability.

The sensing result requiring an immediate report may be delivered to the AMF 1203 as an Nsf_SensingResponse message. The AMF 1203 may deliver a Sensing Request message to the UE 1201 via an N1 interface (NAS) to trigger a necessary sensing operation. When generating a sensing result which should be reported according to an event-triggered or periodic/delay condition, the SF 1204 may deliver an Nsf_EventExposure_Notify message to the VGMSC 1205 in the roaming environment and may directly deliver an Nsf_EventExposure_Notify message to the HGMSC 1206 when there is no roaming. In the roaming environment, the VGMSC 1205 may deliver the result to the HGMSC 1206 using an Ngmsc_EventExposure_Notify message. The HGMSC 1206 may deliver a Sensing Notify message to the sensing client 1208. Furthermore, the HGMSC 1206 may deliver an Ngmsc_EventExposure_Notify message including an event-triggered, periodic, or delay sensing result to an NEF 1209. The NEF 1209 may provide an AF 1210 with the sensing result using an Nnef_EventExposure_Notify or Nnef_SensingExposure_Notify message.

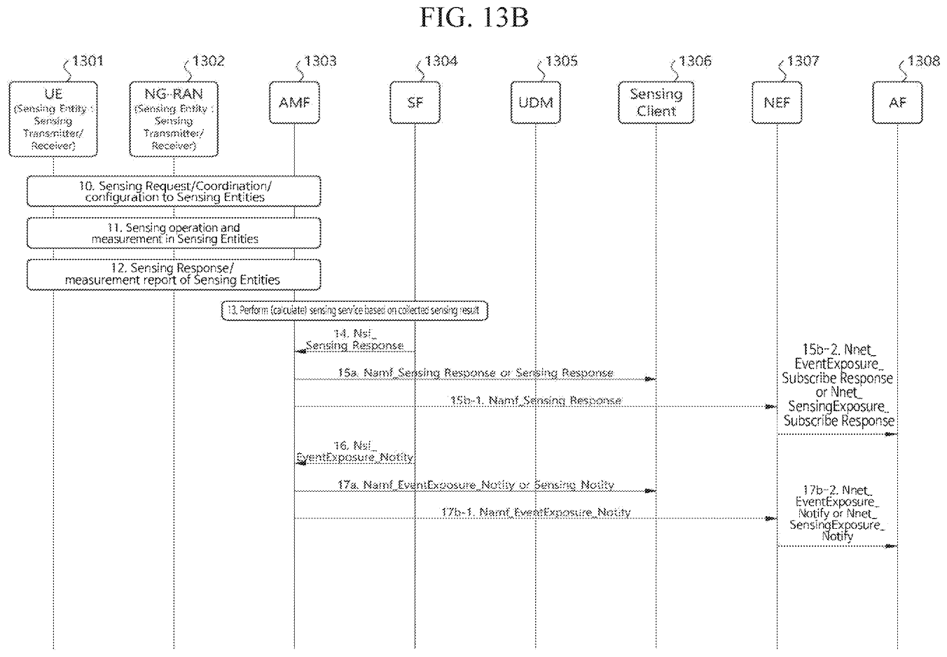

Furthermore, a structure in which the GMSC is not included in FIG. 4 and the SF connected via an SBI and the sensing client are connected with each other may be considered as a structure different from those described above. As an example, the SF may obtain and provide data sensed in a network to the sensing client. In other words, to be different from those described above, the sensing client may have a structure in which it is connected with the SF and may have a structure in which a separate center, such as the GMSC, is not used. The SF may directly deliver sensing data obtained from the network to the sensing client via the SBI and is not limited to a specific form. FIGS. 13A to 24 below may have a structure in which the SF is directly connected with the sensing client without the GMSC.

FIGS. 13A and 13B are drawing illustrating a process of providing a sensing service via procedural linkage among a sensing client, a UDM, an AMF, and an SF according to the present disclosure.

Referring to FIGS. 13A and 13B, to perform a sensing privacy check of a UE 1301 and a sensing service authorization procedure of an AF 1308, a sensing client 1306 may transmit an Nudm_SDM_Get message including at least any one of an AF ID, a client ID, a sensing service type, purpose of sensing, an SUPI or GPSI of the UE, a sensing group, a sensing service area, a time period for sensing, QoS requirements (accuracy of positioning estimate, accuracy of velocity estimate, a confidence level, a missed detection probability, a false alarm probability, max sensing service latency, and a refreshing rate), a sensing report description, a response type (immediate/isolated/periodical/event-triggered), and a sensing event type to a UDM 1305 to perform verification. Herein, the sensing client 1306 may transmit an Nudm_UECM_Get message including the same information set to the UDM 1305 to obtain a network address of an AMF 1303 to check a network address of the AMF 1303. The sensing client 1306 may transmit an Namf_SensingRequest or NAS based Sensing Request message to the AMF 1303. The message may include at least any one of a client ID, purpose of sensing, UE information, QoS requirements, a sensing group, a sensing service area, a sensing report description, and a response type. The AF 1308 may transmit an Nnef_EventExposure_Subscribe or Nnef_SensingExposure_Subscribe message including an AF ID, a notification target address, an event ID, an event type, a report type, and a sensing event type together with the sensing client information to an NEF 1307. The NEF 1307 may transmit an Nudm_SDM_Get message to the UDM 1305 for a privacy check and service authorization and may transmit an Nudm_UECM_Get to the UDM 1305 to search for a network address of the AMF 1303. Thereafter, the NEF 1307 may deliver an Namf_SensingRequest message including the entire request information to the AMF 1303.

When the UE 1301 is in a CM-IDLE state and UE unaware indication is not set, the AMF 1303 may perform a network triggered Service Request procedure to establish a signaling connection with the UE 1301. The AMF 1303 may transmit an N1 Sensing Notification Invoke Request including all pieces of information necessary to perform a Sensing Privacy Notification Verification procedure to the UE 1301. The UE 1301 may deliver an N1 Sensing Notification Return Result including a Verification Response to the AMF 1303. The AMF 1303 may deliver an Nudm_SensingProvisioning Request including a Privacy Verification Result to the UDM 1305 to request to update privacy information of the UE 1301. The AMF 1303 may select an appropriate SF 1304 depending on a local configuration or NF selection criteria proposed in FIG. 3. Thereafter, the AMF 1303 may transmit an Nsf_EventExposure_Subscribe Request message including a notification target address, an event ID, an event Type, and a report type to the SF 1304 to request Sensing Event Notify Subscribe. The SF 1304 may respond to it as an Nsf_EventExposure_Subscribe Response. The AMF 1303 may deliver an Nsf_SensingRequest message including all pieces of information provided from the sensing client 1306 and the AF 1308. The SF 1304 may select one or more sensing entities (e.g., an NG-RAN 1302) and may deliver sensing request, sensing coordination, and sensing configuration information via the AMF 1303 or an N1/N2 message to complete the configuration. Thereafter, the selected sensing entities 1301 and 1302 may perform a sensing operation and measurement. Herein, the measured sensing response or sensing measurement report may be delivered to the SF 1304. This process may be performed via the AMF 1303 or through the N1/N2 message. The SF 1304 may calculate a sensing result based on the collected measurement data. The calculated result may include at least any one of position information, a velocity, a range, an angle, confidence, geometric information, map information, contextual information, a UE ID, sensing assistance information, sensing service latency, accuracy of positioning estimate, accuracy of velocity estimate, a missed detection probability, and a false alarm probability. Thereafter, the result requiring an immediate report may be delivered to the AMF 1303 as an Nsf_SensingResponse message from the SF 1304. The AMF 1303 may directly provide the sensing client 1306 with the sensing result in the form of an Namf_SensingResponse or a Sensing Response. The AMF 1303 may deliver the same result to the NEF 1307 in the form of an Namf_SensingResponse message. The NEF 1307 may deliver the result to the AF 1308 in the form of an Nnef_EventExposure_Subscribe Response or an Nnef_SensingExposure_Subscribe Response. In addition, the SF 1304 may provide the AMF 1303 with a sensing result corresponding to an event-triggered, periodic, or delay condition as an Nsf_EventExposure_Notify message. The AMF 1303 may directly provide the sensing client 1306 with an event-triggered or periodic/delay result in the form of Namf_EventExposure_Notify or Sensing Notify and may simultaneously deliver an Namf_EventExposure_Notify message to the NEF 1307. The NEF 1307 may provide the AF 1308 with the sensing result via an Nnef_EventExposure_Notify or Nnef_SensingExposure_Notify message to complete the entire procedure.

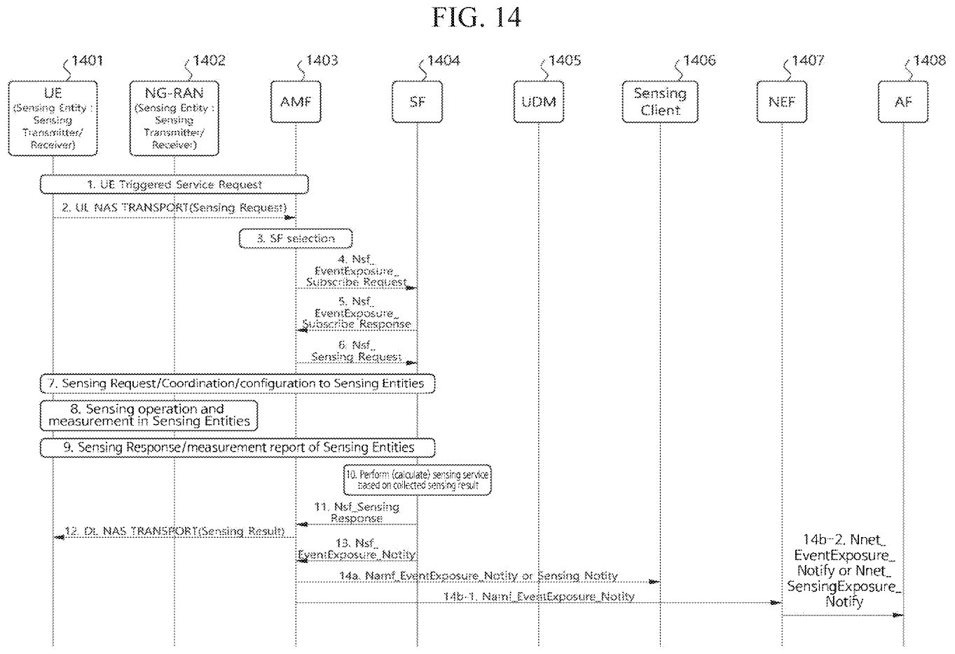

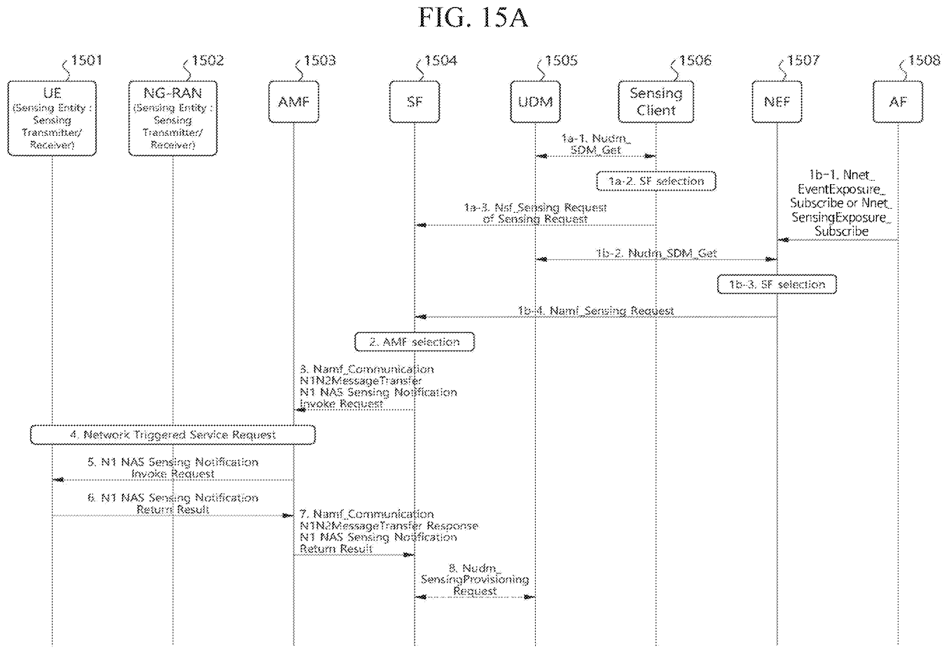

FIG. 14 is a drawing illustrating a UE based sensing service providing procedure using an AMF and an SF according to the present disclosure. Referring to FIG. 14, when a UE 1401 is in a CM-IDLE state, it may perform a UE triggered Service Request procedure to establish a signaling connection with an AMF 1403. A sensing client 1406 may transmit a Sensing Request message to the AMF 1403 via an N1 interface (NAS). The message may include at least any one of a client ID, a sensing service type, purpose of sensing, SUPIs or GPSIs of UEs, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, and a response type. The AMF 1403 may select an appropriate SF 1404 to take charge of sensing processing based on a local configuration or NF selection criteria. Herein, the AMF 1403 may deliver an Nsf_EventExposure_Subscribe Request message including a notification target address, an event ID, an event type, and a report type to the selected SF 1404 to request Sensing Event Notify Subscribe. The SF 1404 may respond to it as an Nsf_EventExposure_Subscribe Response message. The AMF 1403 may deliver an Nsf_SensingRequest message including request information delivered from the sensing client 1406 to the SF 1404. The transmitted information may include at least any one of a client ID, purpose of sensing, UE information, QoS requirements, a sensing group, a sensing report description, a response type, and a sensing event type. The SF 1404 may select one or more sensing entities (e.g., an NG-RAN 1402) to perform sensing and may exchange sensing request, sensing coordination, and sensing configuration information with the selected entities. The above-mentioned exchange process may be performed via Namf_Communication_N1N2MessageTransfer between the SF 1404 and the AMF 1403 or an N1/N2 message among SF-AMF-sensing entity. Furthermore, the selected sensing entity 1402 may perform a sensing operation and may proceed with sensing measurement, depending to a set condition. Herein, the completed sensing response or sensing measurement report may be delivered to the SF 1404 via the AMF 1403 or through the N1/N2 message. Namf_Communication_N1N2MessageTransfer may be used. The SF 1404 may calculate a sensing result based on the collected measurement data. The calculated sensing result may include at least any one of position information, a velocity, a range, an angle, confidence, geometric information, map information, contextual information, a UE ID, sensing assistance information, sensing service latency, accuracy of positioning estimate, accuracy of velocity estimate, a missed detection probability, and a false alarm probability.

The sensing result requiring an immediate report may be delivered to the AMF 1403 in the form of an Nsf_SensingResponse message from the SF 1404. Thereafter, the AMF 1403 may deliver a Sensing Request message to the UE 1401 using an N1 interface (NAS) to trigger an additional sensing operation or report. When generating a sensing result which should be reported in an event-triggered or periodic/delay scheme, the SF 1404 may deliver the result to the AMF 1403 as an Nsf_EventExposure_Notify message. The AMF 1403 may provide the sensing client 1406 with an event-triggered or periodic/delay sensing result in the form of Namf_EventExposure_Notify or Sensing Notify. Furthermore, the AMF 1403 may deliver the same result to an NEF 1407 as an Namf_EventExposure_Notify message. The NEF 1407 may provide an AF 1408 with the sensing result as an Nnef_EventExposure_Notify or Nnef_SensingExposure_Notify message to complete the entire procedure.

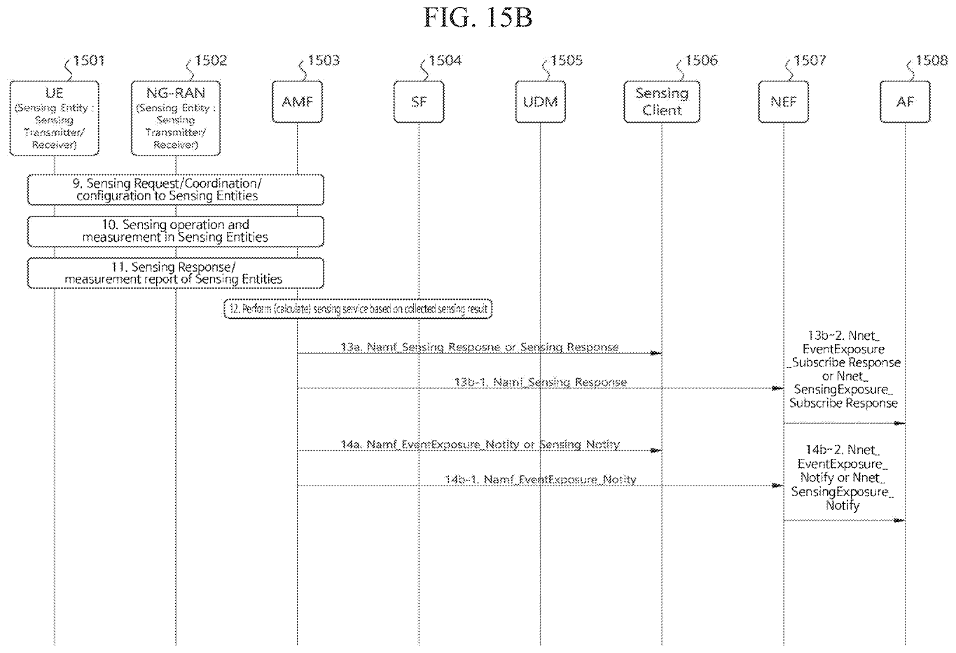

FIGS. 15A and 15B are drawings illustrating a procedure of directly selecting an SF and requesting a sensing service in a sensing client according to the present disclosure.

Referring to FIGS. 15A and 15B, to perform a sensing privacy check of a UE 1501 and sensing service authorization of an AF 1508, a sensing client 1506 may transmit an Nudm_SDM_Get message including at least any one of an AF ID, a client ID, a sensing service type, purpose of sensing, SUPIs or GPSIs of target UEs, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, a response type, and sensing event type information to a UDM 1505 to perform necessary verification. The sensing client 1506 may select an SF 1504 to take charge of sensing processing based on the above-mentioned NF selection criteria or local configuration. Thereafter, the sensing client 1506 may deliver an Nsf_SensingRequest message or a Sensing Request message including the entire sensing request information to the selected SF 1504. The AF 1508 may transmit an Nnef_EventExposure_Subscribe or Nnef_SensingExposure_Subscribe message including an AF ID, a notification target address, an event ID, an event type, and a report type together with request information of the sensing client 1506 to an NEF 1507 to request subscription for an event-triggered report. The NEF 1507 may transmit and check an Nudm_SDM_Get message to the UDM 1505 for a privacy check and authorization. The NEF 1507 may select the appropriate SF 1504 based on the above-mentioned SF selection criteria and then may deliver an Nsf_SensingRequest message including the entire sensing request information to the selected SF 1504. The SF 1504 may perform a local configuration or NRF/UDM based inquiry procedure to select an AMF 1503 supporting a sensing function. The SF 1504 may deliver an N1 NAS Sensing Notification Invoke Request message to the selected AMF 1503 using Namf_Communication_N1N2MessageTransfer to perform a UE based privacy check. Thereafter, when the UE 1501 is in a CM-IDLE state and UE unaware indication is not included, the AMF 1503 may perform a network triggered Service Request procedure to establish a signaling connection with the UE 1501. Thereafter, the AMF 1503 may transmit an N1 Sensing Notification Invoke Request for Sensing Privacy Notification Verification to the UE 1501. The UE 1501 may deliver an N1 Sensing Notification Return Result including a privacy verification result to the AMF 1503. The AMF 1503 may deliver an Namf_Communication_N1N2MessageTransfer Response including the above-mentioned result to the SF 1504. The SF 1504 may transmit an Nudm_SensingProvisioning Request message to the UDM 1505 for privacy provisioning update. The SF 1504 may select a sensing entity 1502 may exchange sensing request, sensing coordination, and sensing configuration information via an SF-AMF or an N1/N2 message. The selected sensing entity 1502 may perform a sensing operation and measurement. The sensing measurement result (a sensing response and a sensing measurement report) may be delivered from the sensing entity 1502 to the SF 1504. The delivery process may be performed via the AMF 1503 or using the N1/N2 message. The SF 1504 may calculate a sensing result based on the collected sensing measurement data. The result data may include at least any one of position information, a velocity, a range, an angle, confidence, geometric information, map information, contextual information, a UE ID, sensing assistance information, sensing service latency, accuracy of positioning estimate, accuracy of velocity estimate, a missed detection probability, and a false alarm probability. The sensing result requiring an immediate report may be directly delivered from the SF 1504 to the sensing client 1506 (in the form of an Nsf_SensingResponse or a Sensing Response) or may be delivered to an NEF 1507. Thereafter, the NEF 1507 may deliver the result to the AF 1508 in the form of Nnef_EventExposure_SubscribeResponse or Nnef_SensingExposure_SubscribeResponse. In addition, when generating a sensing result reported in an event-triggered, periodic, or delay scheme, the SF 1504 may directly deliver the sensing result to the sensing client 1506 in the form of an Nsf_EventExposure_Notify message or a Sensing Response. Furthermore, the SF 1504 may deliver the event-triggered/period/delay result to the NEF 1507. The NEF 1507 may provide the AF 1508 with the result as an Nnef_EventExposure_Notify or Nnef_SensingExposure_Notify message.

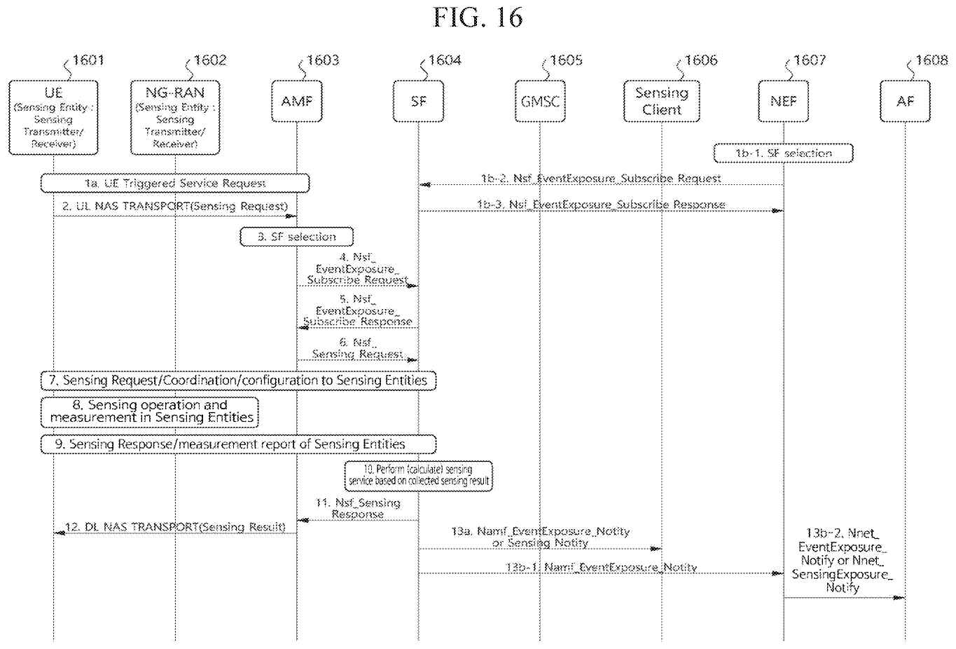

FIG. 16 is a drawing illustrating a GMSC based sensing service providing procedure according to the present disclosure. Referring to FIG. 16, when a UE 1601 is in a CM-IDLE state, it may perform a UE triggered Service Request procedure to establish a signaling connection with an AMF 1603. A GMSC 1605 may select an appropriate SF 1604 to take charge of sensing processing based on the above-mentioned NF selection criteria or local configuration. In a roaming environment, the VGMSC 1605 may transmit an Nsf_EventExposure_Subscribe Request including a notification target address, an event ID, an event type, and a report type to the SF 1604 to request Sensing Event Notify Subscribe. When there is no roaming, the HGMSC 1605 may deliver the same request to the SF 1604. In the roaming environment, the SF 1604 may respond to the VGMSC 1605 as an Nsf_EventExposure_Subscribe Response. When there is no roaming, the SF 1604 may transmit the same response message to the HGMSC 1605. A sensing client 1606 may deliver an N1 NAS based Sensing Request message to the AMF 1603. The message may include at least any one of a client ID, a sensing service type, purpose of sensing, an SUPI or GPSI of the UE, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, and response type information. The AMF 1603 may reselect the appropriate SF 1604 depending to NF selection criteria or a local configuration and may deliver an Nsf_EventExposure_Subscribe Request message including at least any one of a notification target address, an event ID, an event type, and a report type to the selected SF 1604 to request Sensing Event Notify Subscribe. The SF 1604 may respond to it as an Nsf_EventExposure_Subscribe Response message. The AMF 1603 may transmit an Nsf_SensingRequest message including the entire sensing request information delivered from the sensing client 1606 to the SF 1604. The message may include all of a client ID, purpose of sensing, a sensing group, UE information, QoS requirements, a response type, a sensing event type, and the like. The SF 1604 may select one sensing entity 1602 and may set sensing request, sensing coordination, sensing configuration information for the selected sensing entity 1602. The process may be performed via Namf_Communication_N1N2MessageTransfer between the SF 1604 and the AMF 1603 or an N1 or N2 message among SF-AMF-sensing entity. The selected sensing entity 1602 may perform a sensing operation and measurement depending on a sensing function configuration. Thereafter, the generated sensing response or sensing measurement report may be delivered to the SF 1604. The process may be performed via the AMF 1603 or using an N1/N2 message. Namf_Communication_N1N2MessageTransfer may applied to the process. The SF 1604 may calculate a sensing result based on the collected measurement data. The sensing result may include at least any one of position information, a velocity, a range, an angle, confidence, geometric information, map information, contextual information, a UE ID, sensing assistance information, sensing service latency, accuracy of positioning estimate, accuracy of velocity estimate, a missed detection probability, and a false alarm probability. The sensing result requiring an immediate report may be delivered to the AMF 1603 as an Nsf_SensingResponse message from the SF 1604. When there is a need to deliver an N1 NAS based Sensing Request message to the UE 1601, the AMF 1603 may trigger an additional sensing operation. When generating a sensing result which should be reported in an event-triggered, periodic, or delay scheme, the SF 1604 may directly deliver the sensing result to the sensing client 1606 in the form of an Nsf_EventExposure_Notify message or a Sensing Response message. Furthermore, the SF 1604 may deliver the event-triggered or period/delay sensing result to an NEF 1607. Thereafter, the NEF 1607 may report the result to an AF 1608 using an Nnef_EventExposure_Notify or Nnef_SensingExposure_Notify message.

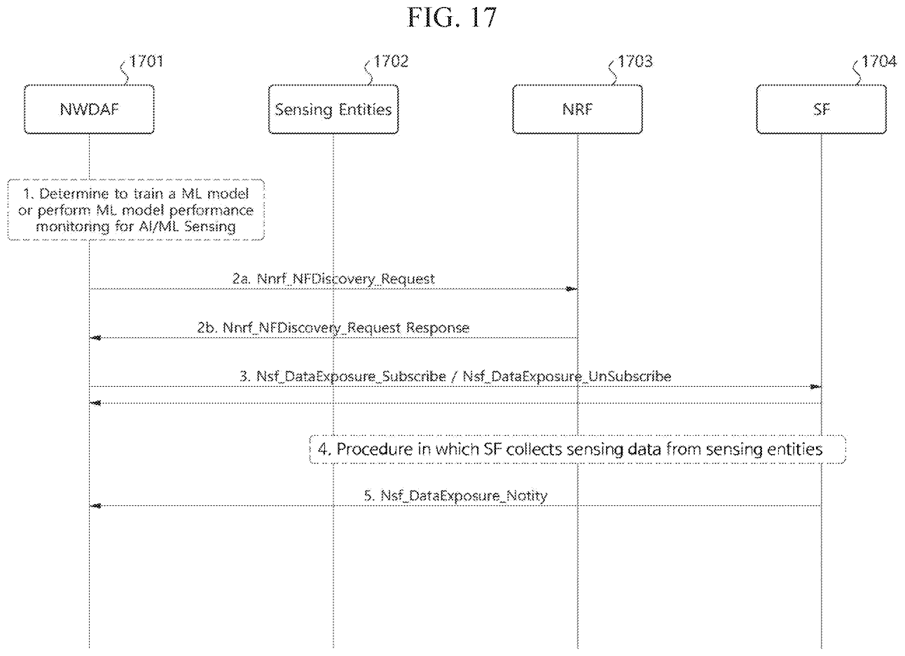

FIG. 17 is a drawing illustrating a procedure of collecting a sensing data sample to train an ML model in an NWDAF according to the present disclosure. Referring to FIG. 17, when it is determined that data for training a sensing ML model is required, an NWDAF 1701 may determine a type and a range of a sensing data sample which should be collected. Thereafter, to select an appropriate SF 1704 to perform sensing data collection, the NWDAF 1701 may deliver an Nnrf_NFDiscovery_Request message which includes the above-mentioned NF selection criteria as a parameter to an NRF 1703. The NRF 1703 may return an Nnrf_NFDiscovery_Request Response message including a network address of the SF 1704, which meets a condition requested by the NWDAF 1701, and SF profile information of the SF 1704 to the NWDAF 1701. The NWDAF 1701 may deliver an Nlmf_DataExposure_Subscribe message including a notification target address and an event ID for requesting to provide a sensing input data sample to the SF 1704, using the obtained information of the SF 1704. In contrast, when desiring to cancel a data sample collection request, the NWDAF 1701 may deliver an Nlmf_DataExposure_UnSubscribe message to the SF 1704. The SF 1704 may perform a procedure for collecting a sensing data sample from a sensing entity 1702. The SF 1704 may transmit an Nlmf_DataExposure_Notify message including the collected sensing data sample to the NWDAF 1701 to deliver the collected sensing data sample to the NWDAF 1701. The NWDAF 1701 may use the delivered sensing data sample as input data for ML model training or AI based sensing analysis.

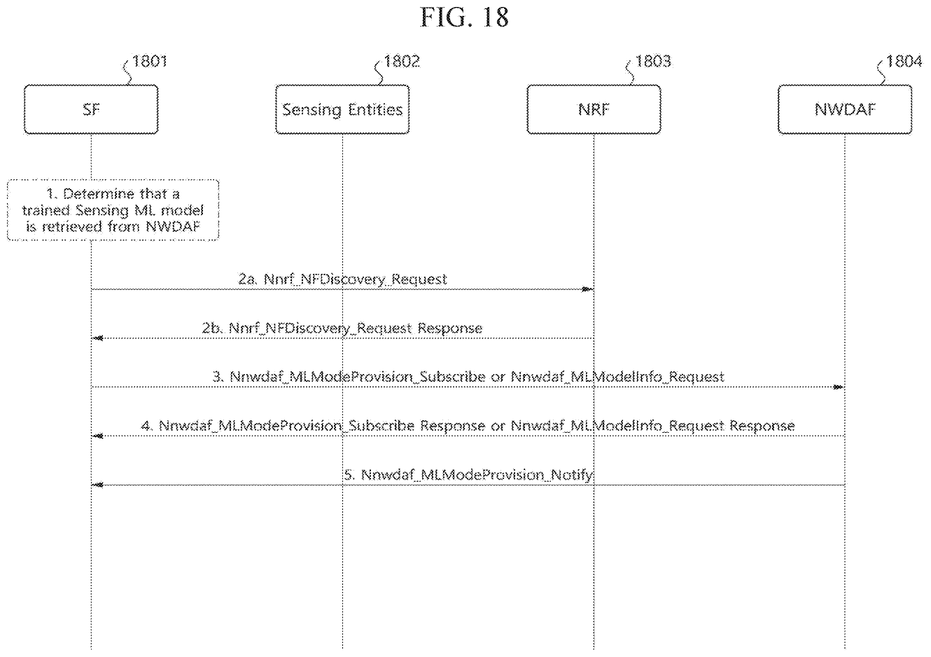

FIG. 18 is a drawing illustrating a procedure of obtaining trained ML model information from an NWDAF to improve sensing accuracy in an SF according to the present disclosure. Referring to FIG. 18, when determining that there is a need to use an ML based sensing function to improve sensing accuracy, an SF 1801 may determine to search for an NWDAF 1804 having pre-trained sensing ML model information. To select the appropriate NWDAF 1804, the SF 1801 may transmit an Nnrf_NFDiscovery_Request message which includes at least any one of supportControlPlaneSensingProtocol, supportUserPlaneSensingProtocol, purpose of sensing, access types, access node types, RAT types, sensing service types, sensing modes, sensing measurements, a target sensing service area, a time period for sensing, a moving target sensing service area, sensing exposure information, transparent sensing, sensing client types, network slicing information, sensing capabilities, a sensing group, accuracy of positioning estimate, accuracy of velocity estimate, a confidence level, a missed detection probability, a false alarm probability, max sensing service latency, a refreshing rate, a sensing report description, a response type, ML model filter Information, an ML model interoperability indicator, and an ML model accuracy checking capability as a parameter to an NRF 1803. The NRF 1803 may return an Nnrf_NFDiscovery_Request Response message including a network address of the NWDAF 1804, which matches the requested condition, and NWDAF profile information to the SF 1801. The SF 1801 may deliver an Nnwdaf_MLModelProvision_Subscribe message including a notification target address, an event ID, an ML model interoperability indication, and AI/ML model Information or an Nnwdaf_MLModelInfo_Request message for ML model inquiry to the NWDAF 1804 to subscribe to ML model provisioning, based on the obtained information of the NWDAF 1804. The NWDAF 1804 may transmit an Nnwdaf_MLModelProvision_Subscribe or Response Nnwdaf_MLModelInfo_Request Response message to the SF 1801 to provide a result for a subscription or information request, depending on the request received from the SF 1801. The NWDAF 1804 may deliver an Nnwdaf_MLModelInfo_Notify message including a trained ML model identifier and ML model information to the SF 1801, such that the SF 1801 is able to use an ML model necessary to improve a sensing function.

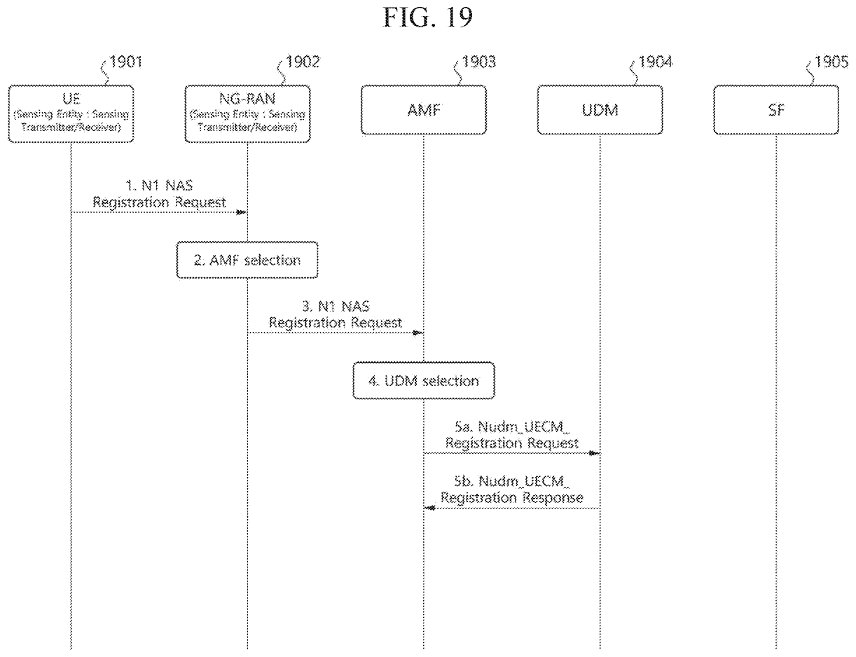

FIG. 19 is a drawing illustrating a procedure for registering sensing function information to a network in UE according to the present disclosure. Referring to FIG. 19, a UE 1901 which operates as a sensing entity may deliver an N1 NAS Registration Request message to an NG-RAN 1902 to provide a network with its sensing capability. The message may include sensing capability information supported by the UE 1901. The information may include at least any one of supportControlPlaneSensingProtocol, supportUserPlaneSensingProtocol, purpose of sensing, access types, access node types, RAT types, sensing service types, support AI, sensing modes, sensing measurements, a target sensing service area, a time period for sensing, a moving target sensing service area, a moving target time period for sensing, sensing exposure Information, transparent sensing, sensing client types, network slicing information, sensing capabilities, a sensing group, accuracy of positioning estimate, accuracy of velocity estimate, a confidence level, a missed detection probability, a false alarm probability, max sensing service latency, a refreshing rate, a sensing report description, and a response type. The NG-RAN 1902 may analyze sensing function information included in a Registration Request message and may select an AMF 1903 consistent with a sensing request and a service policy of the UE 1901. Thereafter, the NG-RAN 1902 may deliver an original Registration Request message to the AMF 1903. The AMF 1903 may check sensing function information included in the Registration Request of the UE 1901 and may select a UDM 1904 for performing an appropriate subscriber data management function to store the information. The AMF 1903 may deliver an Nudm_UECM_Registration message including the sensing function information of the UE 1901 to the selected UDM 1904. Furthermore, the UDM 1904 may receive the Nudm_UECM_Registration message delivered from the AMF 1903 and may store sensing capability information provided by the UE 1901 as subscriber profile data. The stored information may include supportControlPlaneSensingProtocol, supportUserPlaneSensingProtocol, purpose of sensing, access types, access node types, RAT types, sensing service types, support AI, sensing modes, sensing measurements, a target or moving target sensing service area, and at least any one of a time period for sensing, sensing exposure Information, transparent sensing, sensing client types, network slicing information, sensing capabilities, a sensing group, accuracy of positioning estimate, accuracy of velocity estimate, a confidence level, a missed detection probability, a false alarm probability, max sensing service latency, a refreshing rate, a sensing report description, and a response type.

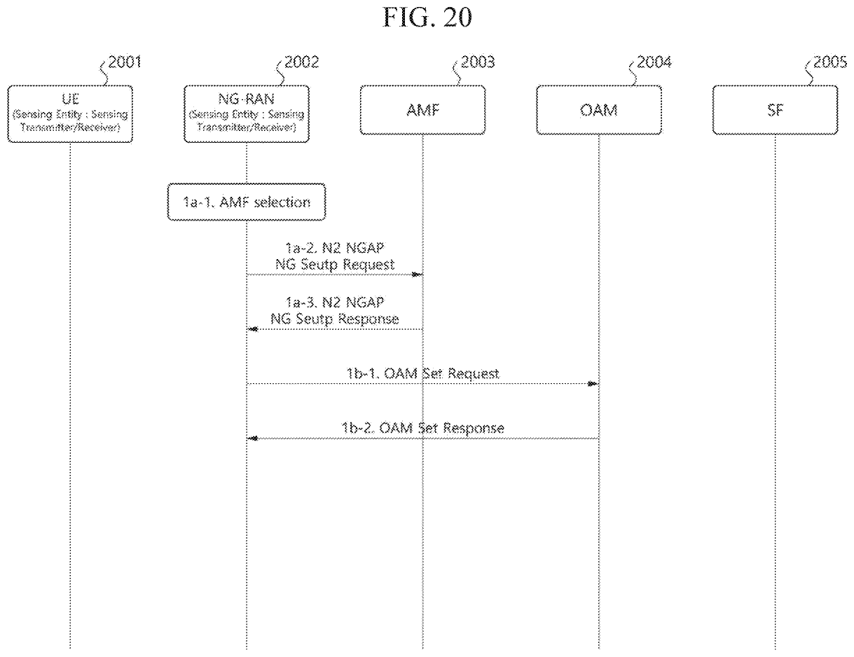

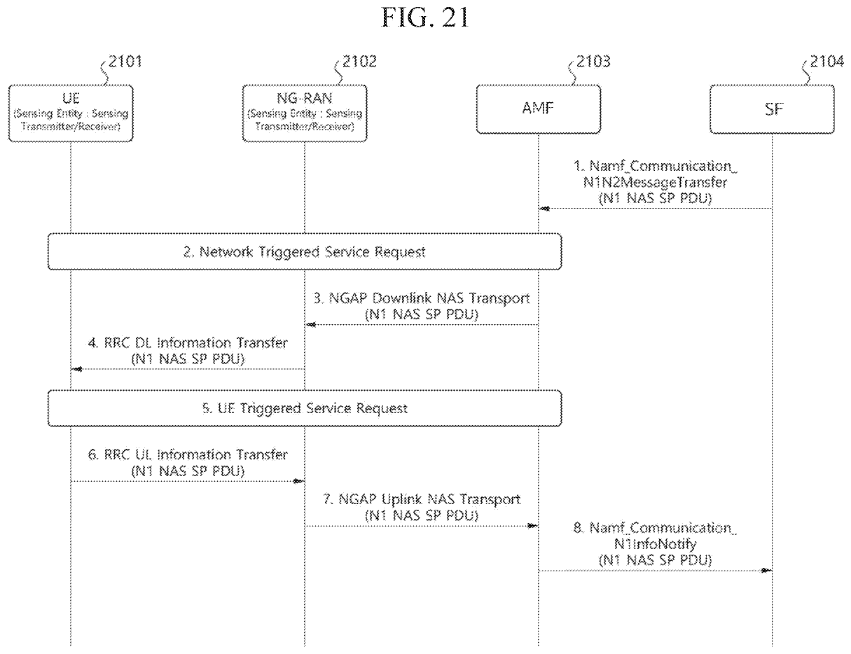

FIG. 20 is a drawing illustrating a procedure for registering sensing function information to a network in an NG-RAN according to the present disclosure. Referring to FIG. 20, an NG-RAN 2002 which operates as a sensing entity may first select an AMF 2003 based on sensing function information supported by the NG-RAN 2002 to provide a network with a sensing capability supported by the NG-RAN 2002. To select the AMF 2003 suitable for processing a sensing service, the NG-RAN 2002 may consider a sensing-related parameter as at least any one of sensing modes providable by the NG-RAN 2002, measurement types, RAT types, support AI, and support sensing exposure to determine the AMF 2003. Thereafter, the NG-RAN 2002 may configure an N2 NGAP NG Setup Request message. The message may include sensing capability information supported by the NG-RAN 2002. The NG-RAN 2002 may deliver the configured Setup Request message to the AMF 2003. The included sensing function information least any include at one of supportControlPlaneSensingProtocol, supportUserPlaneSensingProtocol, purpose of sensing, access types, access node types, RAT types, sensing service types, support AI, sensing modes, sensing measurements, a target sensing service area, a time period for sensing, a moving target sensing service area, a moving target time period for sensing, sensing exposure information, transparent sensing, sensing client types, network slicing information, sensing capabilities, a sensing group, accuracy of positioning estimate, accuracy of velocity estimate, a confidence level, a missed detection probability, a false alarm probability, max sensing service latency, a refreshing rate, a sensing report description, and a response type. Furthermore, to register the same sensing function information to an operations, administration and maintenance (OAM) system, the NG-RAN 2002 may transmit an OAM Set Request message to OAM 2004. The OAM Set Request may include at least any one of supportControlPlaneSensingProtocol, supportUserPlaneSensingProtocol, purpose of sensing, access types, access node types, RAT types, sensing service types, support AI, sensing modes, sensing measurements, a target sensing service area, a time period for sensing, a moving target sensing service area, a moving target time period for sensing, sensing exposure information, transparent sensing, sensing client types, network slicing information, sensing capabilities, a sensing group, QoS requirements (accuracy of positioning estimate, accuracy of velocity estimate, a confidence level, a missed detection probability, a false alarm probability, max sensing service latency, a refreshing rate), a sensing report description, and a response type. The OAM 2004 may receive the sensing function information delivered from the NG-RAN 2002 and may store a sensing capability of the NG-RAN 2002 in a database. The stored information may be used upon sensing function management of the entire network, sensing service policy determination, and sensing computation by an SF 2005, an AMF 2003, and an NWDAF in the future or when a learning model is selected.

Furthermore, hereinafter, the following items may be considered as a function of a sensing protocol between sensing entities and the sensing function (SF) 2005.
Sensing Entities Initialization
Sensing Entities Configuration
Sensing data measurement report
Request Sensing Capabilities
Provide Sensing Capabilities
Request Sensing Assist Data
Provide Sensing Assist Data
Request/Response/Notify Sensing
Request/Response/Notify Sensing Service

FIG. 21 is a drawing illustrating a procedure for delivering NAS based sensing information among UE-NG-RAN-AMF-SF using a Sensing Protocol PDU according to the present disclosure. Referring to FIG. 21, an SF 2104 may generate a Sensing Protocol PDU including sensing-related control information which should be delivered to a UE 2101, may include it in an N1 NAS message, and may delivery Namf_Communication_N1N2MessageTransfer service operation carrying it to an AMF 2103. Herein, the included Sensing Protocol PDU may be composed of at least any one of a sensing measurement command, sensing configuration information, and protocol control information. The AMF 2103 may check the N1 NAS message received from the SF 2104 and may establish a signaling connection with the UE 2101 via a network triggered Service Request procedure, when the UE 2101 is in a CM-IDLE state and UE unaware indication is not included. Thereafter, the AMF 2103 may deliver an N2 NGAP Downlink NAS Transport carrying the N1 NAS message including the sensing protocol PDU to an NG-RAN 2102. The NG-RAN 2102 may receive it and may transmit an RRC DL Information Transfer message including the same N1 NAS message to the UE 2101. When the UE 2101 is the CM-IDLE state at a time point when receiving the message, it may establish a signaling connection with the AMF 2103 by itself via a UE triggered Service Request procedure. The UE 2101 may interpret the received Sensing Protocol PDU, may generate the N1 NAS message including the Sensing Protocol PDU, when a response to it or UL transmission is required, and may deliver an RRC UL Information Transfer carrying it to the NG-RAN 2102. The NG-RAN 2102 may convert the N1 NAS message received from the UE 2101 into an N2 NGAP Uplink NAS Transport message and may deliver the N2 NGAP Uplink NAS Transport message to the AMF 2103. The AMF 2013 may check the N1 NAS message including the Sensing Protocol PDU upwardly reported from the UE 2101 and may deliver Namf_Communication_N1InfoNotify service operation including it to the SF 2104. As a result, the SF 2104 may obtain the sensing measurement result, the state information, and the command performance result of the UE 2101 in real time.

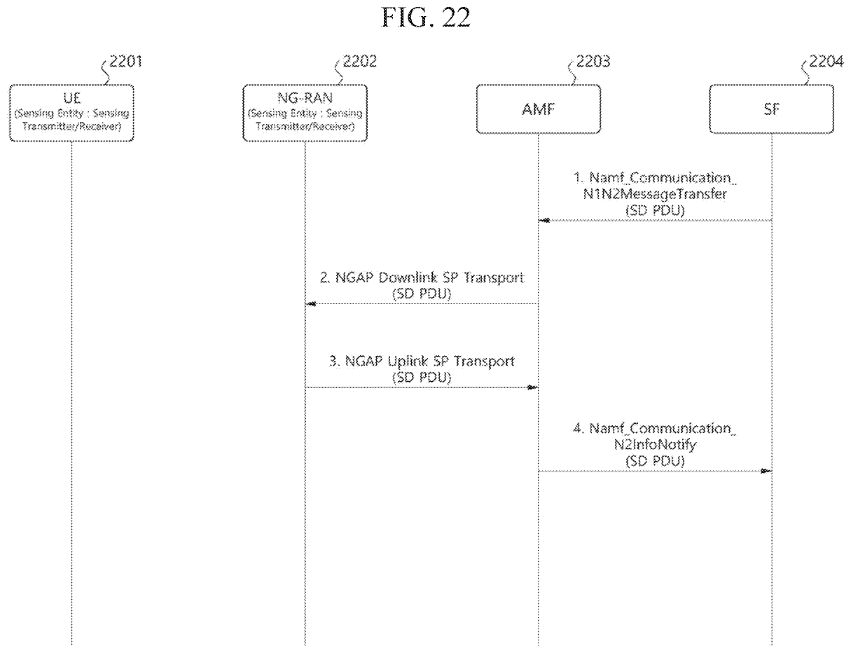

FIG. 22 is a drawing illustrating an N2 based delivery procedure of a Sensing Protocol PDU among NG-RAN-AMF-SF according to the present disclosure. Referring to FIG. 22, an SF 2204 may generate a Sensing Protocol PDU to configure sensing control information which should be delivered to a UE 2201 or an NG-RAN 2202 and may deliver Namf_Communication_N1N2MessageTransfer service operation including it to an AMF 2203. Herein, the Sensing Protocol PDU may include various control fields, such as a sensing measurement configuration, a parameter update, and sensing protocol control information. The AMF 2203 may check the Sensing Protocol PDU delivered from the SF 2204 and may generate an N2 NGAP Downlink sensing protocol (SP) Transport message to deliver it to the NG-RAN 2202. The generated Downlink SP Transport message may include the Sensing Protocol PDU. The NG-RAN 2202 may perform a sensing control operation based on the message. The NG-RAN 2202 may process the Sensing Protocol PDU received from the AMF 2203, may generate an N2 NGAP Uplink sensing protocol (SP) Transport message including the same Sensing Protocol PDU, when a sensing execution result or upper report is required, may deliver it to the AMF 2203. The Uplink SP Transport message may be used for the purpose of delivering a sensing response, a state report, or an additional control performance result of the NG-RAN 2202. Furthermore, the AMF 2203 may check the Sensing Protocol PDU included in the N2 NGAP Uplink SP Transport message delivered from the NG-RAN 2202 and may deliver an Namf_Communication_N2InfoNotify service operation including it to the SF 2204. Via those described above, the SF 2204 may receive the sensing measurement result or the sensing protocol processing result of the NG-RAN 2202 and may perform a subsequent sensing control/analysis procedure.

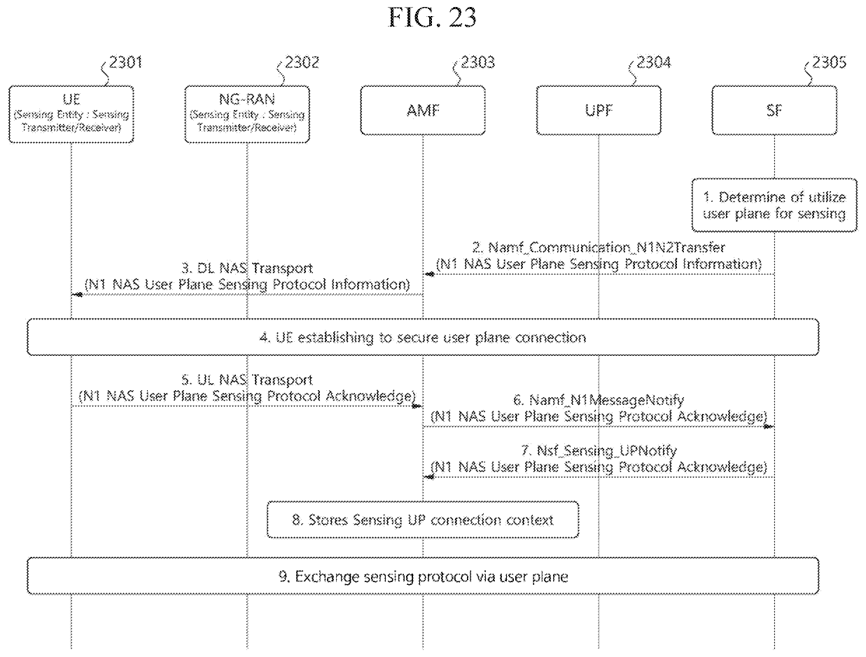

FIG. 23 is a drawing illustrating a user plane establishment procedure between UE-SF for user plane based sensing protocol delivery according to the present disclosure. Referring to FIG. 23, when determining that there is a need for a connection configuration for delivering sensing information via a user plane, an SF 2305 may determine to perform a user plane connection establishment with a UE 2301. The SF 2305 may allocate a sensing UP binding ID for identifying user plane mapping with the UE 2301 and may generate N1 NAS User Plane Sensing Protocol Information including control information necessary to deliver user plane based sensing information. Thereafter, the N1 NAS User Plane Sensing Protocol Information may include at least any one of a sensing UP binding ID, UE identity, a client ID, a sensing service type, purpose of sensing, an SUPI or GPSI of a target UE, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, response type (immediate/isolated/periodical/event-triggered). The SF 2305 may deliver Namf_Communication_N1N2Transfer service operation including it to an AMF 2303. The AMF 2303 may configure a DL NAS TRANSPORT message based on the N1 NAS User Plane Sensing Protocol Information delivered from the SF 2305 and may deliver the message to the UE 2301 via an NG-RAN 2302. The UE 2301 may receive it and may establish a secure user plane connection with the SF 2305. When the user plane establishment is completed, the UE 2301 may generate an N1 NAS User Plane Sensing Protocol Acknowledge message and may deliver a UL NAS TRANSPORT message including the N1 NAS User Plane Sensing Protocol Acknowledge message to the AMF 2303. The AMF 2303 may receive this Acknowledge message, may insert it into Namf_N1MessageNotify service operation, and may provide the SF 2305 with the Namf_N1MessageNotify service operation. The SF 2305 may check the Acknowledge message received from the AMF 2303 and may deliver Nsf_Sensing_UPNotify service operation to the AFM 2303 again to notify the AMF 2303 that the user plane connection establishment is completed. The AMF 2303 may store user plane connection information between the UE 2301 and the SF 2305 in UE context and may use it to transmit a sensing protocol in the future. When the user plane establishment is completed, the UE 2301 and the SF 2305, which provide a sensing function, may directly exchange a sensing protocol message using a user plane path. As a result, the UE 2301 may deliver sensing data, such as a sensing measurement value, estimation information, and environmental information, to a user plane and the SF 2305 may provide a sensing analysis and high-precision sensing service based on the data.

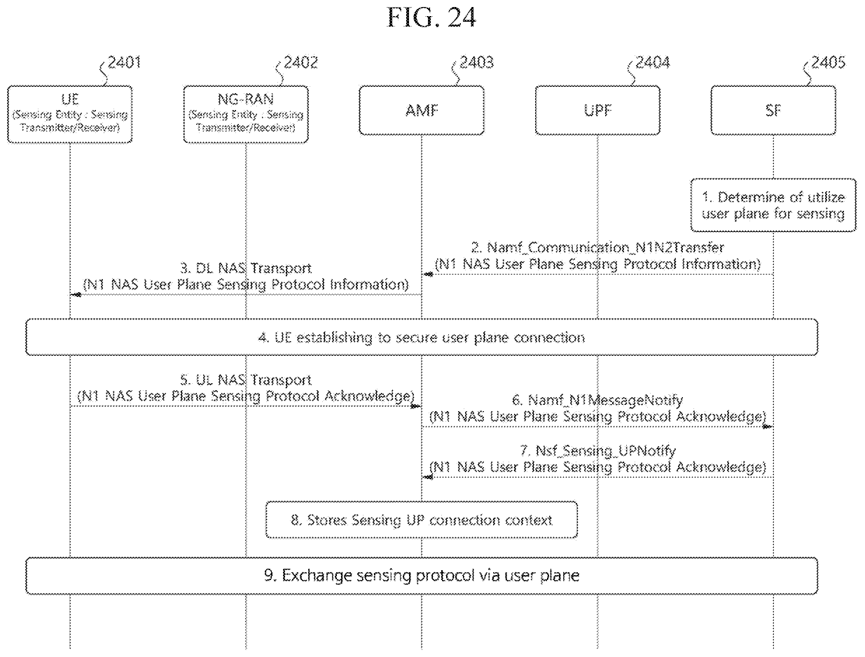

FIG. 24 is a drawing illustrating a user-initiated user plane sensing protocol establishment procedure according to the present disclosure. Referring to FIG. 24, when desiring to start a sensing protocol procedure to perform a user plane based sensing service, a UE 2401 which operates as a sensing entity may generate an N1 NAS message including User Plane Sensing Protocol Initiation information. The User Plane Sensing Protocol Initiation may include at least any one of UE identity, a client ID, a sensing service type, purpose of sensing, an SUPI or GPSI of a target UE, a sensing group, a sensing service area, a time period for sensing, QoS requirements, such as accuracy of positioning estimate, accuracy of velocity estimate, a confidence level, a missed detection probability, a false alarm probability, max sensing service latency, and a refreshing rate, a sensing report description, and a response type (immediate/isolated/periodical/event-triggered). The UE 2401 may deliver a DL NAS TRANSPORT including this Initiation information to an AMF 2403. The AMF 2403 may check the User Plane Sensing Protocol Initiation information delivered from the UE 2401 and may select a sensing function (SF) 2405 depending on a local configuration or NF selection criteria. Thereafter, the AMF 2403 may deliver Nsf_Sensing_UPConfig Request service operation including the UE identity and the N1 NAS User Plane Sensing Protocol Initiation information to the SF 2405. The SF 2405 may newly allocate a sensing UP binding ID for identifying a user plane connection with the UE 2401 and may generate an N1 NAS message including User Plane Sensing Protocol Information. The message may include at least any one of a sensing UP binding ID, UE identity, a client ID, a sensing service type, purpose of sensing, an SUPI or GPSI, a sensing group, a sensing service area, a time period for sensing, QoS requirements, a sensing report description, and a response type. The SF 2405 may deliver Namf_Communication_N1N2Transfer service operation including the generated information to the AMF 2403. The AMF 2403 may include the User Plane Sensing Protocol Information delivered from the SF 2405 in a DL NAS TRANSPORT message and may deliver it the UE 2401 via an NG-RAN 2402. The UE 2401 may establish a secure user plane connection with the SF 2405 based on the delivered User Plane Sensing Protocol Information. When the user plane establishment is successfully completed, the UE 2401 may generate an N1 NAS User Plane Sensing Protocol Acknowledge message and may deliver a UL NAS TRANSPORT message including the N1 NAS User Plane Sensing Protocol Acknowledge message to the AMF 2403. Furthermore, the AMF 2403 may provide the SF 2405 with Namf_N1MessageNotify service operation including this message. The SF 2405 may transmit Nsf_Sensing_UPConfig Response service operation to the AMF 2403 in response to the completion of the user plane configuration. The AMF 2403 may store user plane connection information between the UE 2401 and the SF 2405 and up binding information in UE context. When the user plane connection is established, the UE 2401 and the SF 2405, which perform a sensing function, may exchange a sensing protocol message (a sensing measurement value, an estimation result, sensing control information, or the like) via the user plane. As a result, a high-precision real-time sensing service may be provided.

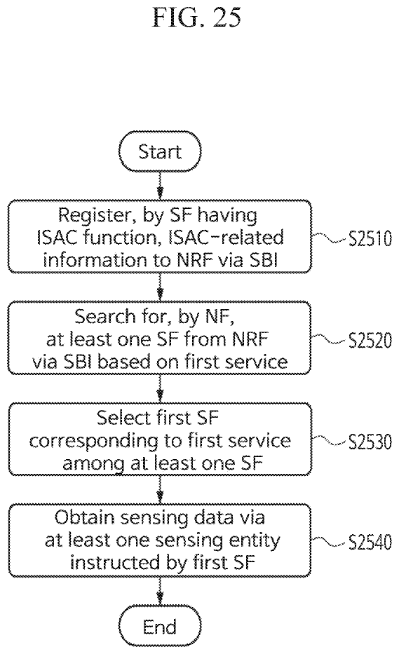

FIG. 25 is a flowchart illustrating a method for providing ISAC-related information applied to the present disclosure. An SF having an ISAC function may register ISAC-related information to an NRF via an SBI (S2510). Thereafter, the NF may search for at least one SF from the NRF via the SBI based on a first service (S250). In other words, the SF having the ISAC function may be registered to the NRF and may be selected by another NF. Herein, a first SF corresponding to the first service among the at least one SF registered to the NRF may be selected (S2530). Sensing data may be obtained via at least one sensing entity instructed by the first SF (S2540). In other words, sensing entities which obtain sensing data based on the first SF may be selected based on a parameter set by the first SF and the obtained sensing data may be delivered over a network from the sensing entities. Herein, the SF may include a parameter for at least any one of an SF ID, sensing target types, access types, access node types, radio access technology (RAT) types, sensing service types, support artificial intelligence (AI), sensing modes, sensing measurements, a target sensing service area, a moving target sensing service area, sensing exposure information, transparent sensing, sensing client types, a sensing load, network slice information, an SF location, performance requirements, a serving sensing protocol, a serving user plane sensing protocol, and serving sensing capabilities. This is as described above. The first SF may be selected among the at least one SF based on the at least one parameter. As an example, the SF having the ISAC function may provide the NRF with an NF profile based on the at least one parameter. Furthermore, when an AMF supporting the ISAC function is registered to the NRF via the SBI and the NRF performs an ISAC operation via the first SF selected based on the first service, the AMF supporting the ISAC function among at least one AMF may be selected. Herein, when the AMF obtains at least any one of ISAC capability information and ISAC radio capability information from at least any one of a user terminal and a base station as sensing entities and the AMF supporting the ISAC function is selected, selection for the AMF may be performed based on the information obtained by the AMF. Furthermore, when a session management function (SMF) supporting the ISAC function is registered to the NRF via the SBI and the NRF performs the ISAC operation via the first SF selected based on the first service, the SMF supporting the ISAC function among at least one SMF may be selected. Furthermore, when a UPF supporting the ISAC function is registered to the NRF via the SBI and the NRF performs the ISAC operation via the first SF selected based on the first service, the UPF supporting the ISAC function among at least one UPF may be selected. Herein, when the UPF is registered to the NRF based on a user plane function feature including whether to support the ISAC function and an ISAC support function and the UPF supporting the ISAC function is selected, selection for the UPF may be performed based on whether the UPF supports the ISAC function and whether the UPF includes the ISAC support function. Furthermore, a network exposure function (NEF) may receive a sensing service request from at least any one of an application function (AF) and a gateway mobile sensing center (GSMC) and may perform sensing service authentication based on the sensing service request. Herein, the first SF may be selected based on the sensing service authentication and sensing data obtained via at least one sensing entity instructed by the first SF may be delivered to at least any one of the AF and the GSMC.

As an example, when a sensing client may be connected with the GSMC and the GSMC is connected via the SBI, the NEF may deliver sensing data to the sensing client via the GSMC. As another example, the GSMC may be directly connected with the SBI, sensing service authentication may be performed based on the request of the sensing client connected with the GSMC, and sensing data may be obtained to be delivered to the sensing client via the GSMC.

Furthermore, when the sensing client is connected with the SF, the NEF may deliver the sensing data to the sensing client via the SF. As another example, the SF may be directly connected with the SBI, sensing service authentication may be performed based on the request of the sensing client connected with the SF, and sensing data may be obtained to be delivered to the sensing client via the SF.

Furthermore, the NEF may perform the sensing service authentication based on at least any one of an AF ID, a client ID, a sensing service type, purpose of sensing, an identifier of a terminal, a sensing group, a sensing service area, a time period for sensing, QoS requirements, accuracy of velocity estimate, a confidence level, a missed detection probability, a false alarm probability, max sensing service latency, a sensing report description, a response type, and a sensing event type based on the sensing service request of at least any one of the AF and the GSMC.

Meanwhile, the embodiment of the present disclosure is not implemented only through the device and the method described above, and may be implemented through a program to execute functions corresponding to the configurations of the embodiment of the present disclosure or a recordable medium having the program recorded therein. The implementation may be easily realized by those having ordinary skill in the art based on the description of the above-mentioned embodiment. In detail, the method (e.g., the network management method, the data transmission method, the transmission schedule generation method, or the like) according to an embodiment of the present disclosure may be implemented in the form of a program command capable of being performed via various computer means to be recorded in a computer-readable medium. The computer-readable medium may include program commands, data files, data structures, or the like alone or in combination. The program commands recorded in the computer-readable medium may be specially designed and configured for the embodiment of the present disclosure or may also be known and available to those skilled in computer software. The computer-readable medium may include a hardware device configured to store and perform the program commands. For example, the computer-readable medium may include magnetic media, such as a hard disk, a floppy disk, and a magnetic tape, optical media, such as a CD-ROM and a DVD, magneto-optical media, such as a floptical disk, read only memories (ROMs), random access memories (RAMs), flash memories, and the like. The program commands may include not only a mechanical code, such as things generated by a compiler, but also a high-level language code executable by a computer using an interpreter or the like.

The present disclosure may provide the method and the system for providing the ISAC function in the mobile communication system.

The present disclosure may provide the method for performing the communication between the sensing entity and network functions (NFs) supporting the ISAC function.

The present disclosure may provide the method for having at least any one of the SF and the GMSC to support the ISAC function, based on the SBI.

The present disclosure may provide the method for delivering the integrated sensing and communications (ISAC) function information to the AMF in the NG-RAN node supporting the ISAC function.

The present disclosure may provide the method for performing the registration to the NRF in the SF, the AMF, the SMF, and the UPF supporting the ISAC function.

The present disclosure may provide the method for searching for the SF, the AMF, the SMF, and the UPF having the ISAC function via the NRF in the NF.

The effects that are achieved through embodiments of the present disclosure may not be limited to what has been particularly described herein, and other advantages not described herein may be more clearly derived and understood from the following detailed description for the embodiments of the present disclosure by persons skilled in the art. In other words, unintended effects according to the execution of the configuration described in the present disclosure may also be derived by those skilled in the art from embodiments of the present disclosure.

Although embodiments of the present disclosure have been described in detail, the scope of the present disclosure is not limited by such embodiments. Various changes and modifications using the basic concept of the present disclosure defined in the accompanying claims by those having ordinary skill in the art should be construed to belong to the scope of the present disclosure.

What is claimed is:

1. A method for providing integrated sensing and communications (ISAC)-related information in a wireless communication system, the method comprising:
registering, by a sensing function (SF) having a sensing function, sensing-related information with a network repository function (NRF) via a service based interface (SBI);
searching for, by a network function (NF), at least one SF from the NRF via the SBI based on a first service;
selecting a first SF corresponding to the first service among the at least one SF; and
obtaining sensing data via at least one entity instructed by the first SF.

2. The method of claim 1, wherein the SF includes a parameter for at least any one of an SF ID, sensing target types, access types, access node types, radio access technology (RAT) types, sensing service types, support artificial intelligence (AI), sensing modes, sensing measurements, a target sensing service area, a moving target sensing service area, sensing exposure information, transparent sensing, sensing client types, a sensing load, network slice information, an SF location, performance requirements, a serving sensing protocol, a serving user plane sensing protocol, and serving sensing capabilities, and
wherein the first SF is selected among the at least one SF based on the at least one parameter.

3. The method of claim 2, wherein the SF having the sensing function provides the NRF with an NF profile based on the at least one parameter.

4. The method of claim 2, wherein, when an access management function (AMF) supporting the sensing function is registered to the NRF via the SBI and the NRF performs a sensing operation via the first SF selected based on the first service, the AMF supporting the sensing function among at least one AMF is selected.

5. The method of claim 4, wherein, when the AMF obtains at least any one of sensing capability information and sensing radio capability information from at least any one of a user terminal and a base station as sensing entities and the AMF supporting the sensing function is selected, selection for the AMF is performed based on the information obtained by the AMF.

6. The method of claim 1, wherein, when a session management function (SMF) supporting the sensing function is registered to the NRF via the SBI and the NRF performs a sensing operation via the first SF selected based on the first service, the SMF supporting the sensing function among at least one SMF is selected.

7. The method of claim 1, wherein, when a user plane function (UPF) supporting the sensing function is registered to the NRF via the SBI and the NRF performs a sensing operation via the first SF selected based on the first service, the UPF supporting the sensing function among at least one UPF is selected.

8. The method of claim 7, wherein, when the UPF is registered to the NRF based on a user plane function feature including whether to support the sensing function and a sensing support function and the UPF supporting the sensing function is selected, selection for the UPF is performed based on whether the UPF supports the sensing function and whether the UPF includes the sensor support function.

9. A method for providing integrated sensing and communications (ISAC)-related sensing service in a wireless communication system, the method comprising:
receiving, by a network exposure function (NEF), a sensing service request from at least any one of an application function (AF) and a gateway mobile sensing center (GMSC);
performing sensing service authentication based on the sensing service request;
selecting a sensing function (SF) based on the sensing service authentication; and
delivering sensing data obtained via at least one sensing entity instructed by the selected SF to the at least any one of the AF and the GMSC.

10. The method of claim 9, wherein, when a sensing client is connected with the GMSC and the GMSC is connected via a service based interface (SBI), the NEF delivers the sensing data to the sensing client via the GMSC.

11. The method of claim 9, wherein, when a sensing client is connected with the SF, the NEF delivers the sensing data to the sensing client via the SF.

12. The method of claim 9, wherein the NEF performs the sensing service authentication based on at least any one of an AF ID, a client ID, a sensing service type, purpose of sensing, an identifier of a terminal, a sensing group, a sensing service area, a time period for sensing, QoS requirements, accuracy of velocity estimate, a confidence level, a missed detection probability, a false alarm probability, max sensing service latency, a sensing report description, a response type, and a sensing event type based on the sensing service request of the at least any one of the AF and the GMSC.

13. An apparatus for providing integrated sensing and communications (ISAC)-related information in a wireless communication system, the apparatus comprising:
a memory storing at least one program;
a transceiver configured to transmit and receive at least one signal; and
a processor configured to execute the at least one program stored in the memory,
wherein the processor is configured to:
register sensing-related information with a network repository function (NRF) via a service based interface (SBI) in a sensing function (SF) having a sensing function;
search for at least one SF from the NRF via the SBI based on a first service in a network function (NF);
select a first SF corresponding to the first service among the at least one SF; and
obtain sensing data via at least one entity instructed by the first SF.

14. The apparatus of claim 13, wherein the SF includes a parameter for at least any one of an SF ID, sensing target types, access types, access node types, radio access technology (RAT) types, sensing service types, support artificial intelligence (AI), sensing modes, sensing measurements, a target sensing service area, a moving target sensing service area, sensing exposure information, transparent sensing, sensing client types, a sensing load, network slice information, an SF location, performance requirements, a serving sensing protocol, a serving user plane sensing protocol, and serving sensing capabilities, and
wherein the first SF is selected among the at least one SF based on the at least one parameter.

15. The apparatus of claim 13, wherein the processor is configured to:
when an access management function (AMF) supporting the sensing function is registered to the NRF via the SBI and the NRF performs a sensing operation via the first SF selected based on the first service, select the AMF supporting the sensing function among at least one AMF.

16. The apparatus of claim 13, wherein the processor is configured to:
when a session management function (SMF) or a user plane function (UPF) supporting the sensing function is registered to the NRF via the SBI and the NRF performs a sensing operation via the first SF selected based on the first service, select the SMF or the UPF supporting the sensing function among at least one SMF or UPF.

17. An apparatus for providing integrated sensing and communications (ISAC)-related sensing service in a wireless communication system, the apparatus comprising:
a memory storing at least one program;
a transceiver configured to transmit and receive at least one signal; and
a processor configured to execute the at least one program stored in the memory,
wherein the processor is configured to:
receive a sensing service request from at least any one of an application function (AF) and a gateway mobile sensing center (GMSC) in a network exposure function (NEF);
perform sensing service authentication based on the sensing service request;
select a sensing function (SF) based on the sensing service authentication; and
deliver sensing data obtained via at least one sensing entity instructed by the selected SF to the at least any one of the AF and the GMSC.

18. The apparatus of claim 17, wherein, when a sensing client is connected with the GMSC and the GMSC is connected via a service based interface (SBI), the NEF delivers the sensing data to the sensing client via the GMSC.

19. The apparatus of claim 17, wherein, when a sensing client is connected with the SF, the NEF delivers the sensing data to the sensing client via the SF.

20. The apparatus of claim 17, wherein the NEF performs the sensing service authentication based on at least any one of an AF ID, a client ID, a sensing service type, purpose of sensing, an identifier of a terminal, a sensing group, a sensing service area, a time period for sensing, QoS requirements, accuracy of velocity estimate, a confidence level, a missed detection probability, a false alarm probability, max sensing service latency, a sensing report description, a response type, and a sensing event type based on the sensing service request of the at least any one of the AF and the GMSC.
